(19) United States
(12) Patent Application Publication
(10) Pub. No.: US 2018/0112887 A1
(43) Pub. Date: Apr. 26, 2018

(54) DUCT TECHNOLOGIES

(71) Applicant: Green HVAC Ducts USA, LLC, White Plains, NY (US)

(72) Inventors: Carl Fanelli, Mahopac, NY (US); Bernard Kulkaski, Pine Grove, PA (US)

(21) Appl. No.: 15/557,399

(22) PCT Filed: Mar. 17, 2016
(86) PCT No.: PCT/US16/22771

§ 371 Date: Sep. 11, 2017

Related U.S. Application Data
(60) Provisional application No. 62/134,516, filed on Mar. 17, 2015.
(60) Provisional application No. 62/238,936, filed on Oct. 8, 2015.

(51) Int. Cl. F24F 13/02; F16L 9/00; F24F 11/30

(52) U.S. Cl. CPC F24F 13/0263; F24F 11/30; F16L 9/003; F24F 13/0245

(57) ABSTRACT

Various ducts and methods of manufacture, use, and transport are disclosed. The present disclosure at least partially addresses at least one of the above. However, the present disclosure can prove useful to other technical areas. Therefore, the claims should not be construed as necessarily limited to addressing any of the above. An embodiment comprises a method comprising: accessing a duct comprising an outer portion and an inner portion, wherein the outer portion comprises an L-shaped segment comprising a first end portion and a second end portion, wherein the first end portion comprises a first winglet extending therefrom, wherein the second end portion comprises a second winglet extending therefrom, wherein the first winglet and the second winglet contact the inner portion such that a channel is defined between the L-shaped segment and the inner portion; conducting a fluid through the inner portion.

### CROSS REFERENCE TO RELATED APPLICATIONS

This application claims the benefit of U.S. Provisional Patent Application 62/238,936 filed 8 Oct. 2015 and U.S. Provisional Patent Application 62/134,516 filed 17 Mar. 2015; each of which is herein fully incorporated by reference for all purposes.

### TECHNICAL FIELD

The present disclosure relates to ducts.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure may be concerned with. Further, nothing is disclaimed.

A heating, ventilation, and air conditioning (HVAC) system is generally used to provide a comfortable air environment, whether indoors or in a vehicular cabin. For example, the HVAC system can provide temperature comfort or acceptable air quality in a building, whether residential or commercial. Accordingly, the HVAC system typically contains a ductwork, which includes a set of interconnected ducts configured to conduct forced air therethrough.

Installation, use, or maintenance of the HVAC system is generally regulated by a legal code, such as a local building code. Among other things, the legal code often mandates that the ductwork of the HVAC system be insulated, such as during installation, use, or maintenance of the HVAC system. One reason for such mandate is to encourage efficiency in energy use. Resultantly, when the HVAC system is in operation, the insulation reduces thermal energy transfer between the forced air within the ductwork of the HVAC system and ambient air outside the ductwork of the HVAC system. Such reduction of the thermal energy transfer encourages efficiency in energy use.

One method of insulating the ductwork of the HVAC system, for compliance with the legal code, involves wrapping an insulation jacket around many, if not all, of the ducts of the ductwork of the HVAC system and then sealing, such as via a tape, any remaining seams in the ductwork of the HVAC system, outside of the insulation jacket. Subsequently, the HVAC system is pressure tested to ensure absence of substantial leaks of the forced air from within the ductwork of the HVAC system to outside the ductwork of the HVAC system. Although such method is sometimes effective, various drawbacks remain. For example, the method can be time consuming or costly to implement.

### BRIEF SUMMARY

The present disclosure at least partially addresses at least one of the above. However, the present disclosure can prove useful to other technical areas. Therefore, the claims should not be construed as necessarily limited to addressing any of the above.

An embodiment comprises a method comprising: accessing a duct comprising an outer portion and an inner portion, wherein the outer portion comprises an L-shaped segment comprising a first end portion and a second end portion, wherein the first end portion comprises a first winglet extending therefrom, wherein the second end portion comprises a second winglet extending therefrom, wherein the first winglet and the second winglet contact the inner portion such that a channel is defined between the L-shaped segment and the inner portion; conducting a fluid through the inner portion.

An embodiment comprises a method comprising: accessing a duct comprising an outer portion and an inner portion, wherein the outer portion and the inner portion is defined via a segment comprising an L-shaped portion and a plate portion, wherein the L-shaped portion comprises a first end portion and a second end portion, wherein the L-shaped segment comprises an inner corner between the first end portion and the second end portion, wherein the first end portion comprises a first winglet extending therefrom, wherein the second end portion comprises a second winglet extending therefrom, wherein the plate portion comprises a plate comprising a first end section and a second end section, wherein the first end section comprises a first wing extending therefrom, wherein the second end section comprises a second wing extending therefrom, wherein at least one of the first winglet or the second winglet contacts the plate between the first wing and the second wing, wherein at least one of the first wing or the second wing extends towards the inner corner; conducting a fluid through the inner portion along the plate.

An embodiment comprises a method comprising: accessing a duct comprising an outer portion and an inner portion, wherein the inner portion comprises a segment comprising a plurality of W-shaped portions and a bridge portion, wherein the bridge portion spans between the W-shaped portions; conducting a fluid through the inner portion along the bridge portion.

The present disclosure may be embodied in the form illustrated in the accompanying drawings. However, attention is called to the fact that the drawings are illustrative. Variations are contemplated as being part of the disclosure, limited only by the scope of the claims.

### BRIEF DESCRIPTION OF DRAWINGS

The accompanying drawings illustrate example embodiments of the present disclosure. Such drawings are not to be construed as necessarily limiting the disclosure. Like numbers and/or similar numbering scheme can refer to like and/or similar elements throughout.

FIG. 1 shows a perspective view of an example embodiment of a duct according to the present disclosure.

FIG. 2 shows an exploded view of an example embodiment of a duct according to the present disclosure.

FIG. 3 shows a perspective view of an example embodiment of a segment of an outer portion of a duct according to the present disclosure.

FIG. 4 shows a perspective view of an example embodiment of a segment of an inner portion of a duct according to the present disclosure.

FIG. 5 shows a top view, a profile view, and a perspective view of an example embodiment of a segment of an inner portion of a duct according to the present disclosure.

FIG. 6 shows a perspective view of an example embodiment of a segment of a duct according to the present disclosure.

FIGS. 7-9 show a plurality of perspective views of an example embodiment of a first segment of a duct being interlocked with a second segment of a duct according to the present disclosure.

FIGS. 10-12 show a plurality of perspective views of an example embodiment of a plurality of duct segments according to the present disclosure.

FIGS. 13-15 show a plurality of perspective views of an example embodiment of a duct assembled via a plurality of duct segments according to the present disclosure.

FIGS. 16-17 show a plurality of perspective views of an example embodiment of a duct assembled via a plurality of duct segments and containing a plurality of insulating segments according to the present disclosure.

FIGS. 18-19 show a plurality of perspective views of an example embodiment of a duct assembled via a plurality of duct segments and lacking a plurality of insulating segments according to the present disclosure.

FIGS. 20-22 show a plurality of schematic diagrams depicting a plurality of example embodiments of duct technologies according to the present disclosure.

FIGS. 23A-23B show an embodiment of a duct interlocking at a corner according to the present disclosure.

FIGS. 24A-24B show an embodiment of a duct engagement at a corner according to the present disclosure.

### DETAILED DESCRIPTION OF PREFERRED EMBODIMENTS

The present disclosure is now described more fully with reference to the accompanying drawings, in which example embodiments of the present disclosure are shown. The present disclosure may, however, be embodied in many different forms and should not be construed as necessarily being limited to the example embodiments disclosed herein. Rather, these example embodiments are provided so that the present disclosure is thorough and complete, and fully conveys the concepts of the present disclosure to those skilled in the relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (3D) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, a gemstone, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings were turned over, then the elements described as being on the “lower” side of other elements would then be oriented on “upper” sides of the other elements. Similarly, if the device in one of the figures were turned over, elements described as “below” or “beneath” other elements would then be oriented “above” the other elements. Therefore, the example terms “below” and “lower” can encompass both an orientation of above and below.

As used herein, the term “about” and/or “substantially” refers to a +/−10% variation from the nominal value/term. Such variation is always included in any given value/term provided herein, whether or not such variation is specifically referred thereto.

U.S. Pat. No. 8,667,995 is herein fully incorporated by reference for all purposes. If any disclosures are incorporated herein by reference and such disclosures conflict in part and/or in whole with the present disclosure, then to the extent of conflict, and/or broader disclosure, and/or broader definition of terms, the present disclosure controls. If such disclosures conflict in part and/or in whole with one another, then to the extent of conflict, the later-dated disclosure controls.

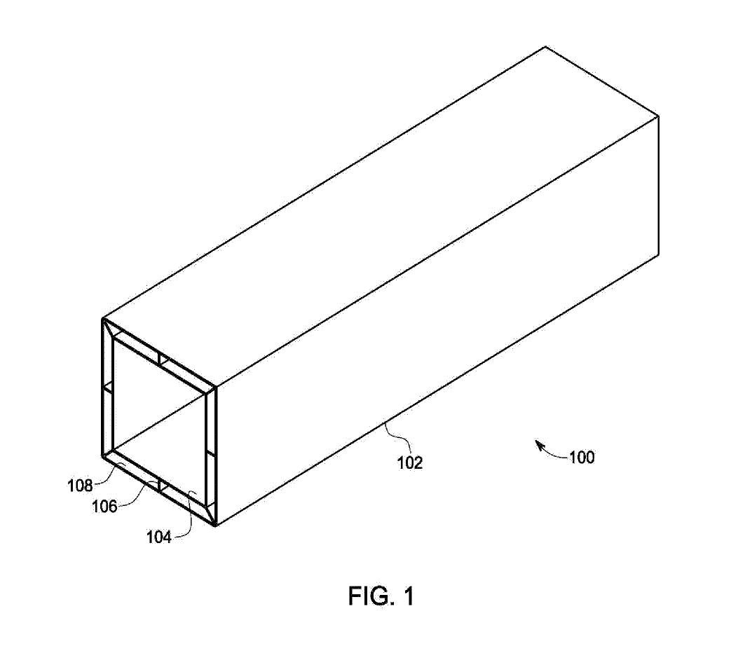

FIG. 1 shows a perspective view of a duct according to the present disclosure. A duct 100 is operative for use in an HVAC system in order to conduct or convey a forced fluid, such as a liquid or a gas. For example, the HVAC system can be indoors, such as in a building, whether residential or commercial, or in a vehicular cabin, such in a land vehicle, a marine vehicle, or an aerial vehicle. Also, for example, the fluid can include water or air. Further, for example, the forced fluid can be used in non-HVAC systems as well, such as any type of fluid conduction, whether forced or gravity induced.

In some embodiments, the duct 100 is operative for use aboveground, underground, or underwater, whether rested, suspended, raised, or buried, whether positioned on a waterbed or buried underneath the waterbed. In some embodiments, the duct 100 is operative for use as an electrical conduit, such as for protection or routing of electrical wiring. In some embodiments, the duct 100 is operative for use as a cable conduit, such as for protection or routing of network cables. In some embodiments, the duct 100 is operative for pipeline transport use, such as crude, petroleum, fuels, oil, natural gas, hydrogen, ammonia, biofuel, sewage, slurry, non-alcoholic or alcoholic beverage, irrigation, steam, district heating, or other substances, whether chemically stable or unstable, whether lightly or heavily pressurized. In some embodiments, the duct 100 is an interconnector between at least two ducts. In some embodiments, the duct 100 is an interconnector between a duct and at least one of a fluid input device, such as a fluid source, or a fluid output device, such as at least one of a container, a valve, or a spigot.

The duct 100 includes an outer tubular portion 102, an inner tubular portion 104, and a set of walls 106. The portion 104 extends within the portion 102 longitudinally. The walls 106 span between the portion 102 and the portion 104, while extending along the portion 102 and the portion 104 longitudinally, such that a set of channels 108 is defined thereby. For example, at least one of the channels 108 comprises a cavity.

The portion 102 can be configured to conduct the forced fluid therethrough or for other uses, as described herein. The portion 102 can be of any size, length, width, depth, shape, volume, thickness, or cross-section, such as triangular, circular, oval, rectangular, square, trapezoid or any other geometric shape. The portion 102 can be seamed or seamless, whether internally or externally. The portion 102 can include plastic, metal, wood, glass, stone, rubber, or any other material, whether biodegradable, flame-retardant, bacteria-resistant, or leak-proof, whether internally or externally. The portion 102 can extend longitudinally in a rectilinear, arcuate, sinusoidal, zigzag, or any other manner. The portion 102 can be of any color, such as white, black, blue, red, orange, purple, or others, whether internally or externally. The portion 102 can be reflective or non-reflective, whether internally or externally. The portion 102 can define an aperture, whether internally or externally, for use with a fastener, such as a screw. The portion 102 can be rigid or flexible. The portion 102 can be transparent, translucent, or opaque. The portion 102 can be solid or perforated. The portion 102 can define a lattice or a mesh. In some embodiments, the portion 102 can be about ⅛ inch thick, about 4 feet long and has an R-value measuring thermal insulation of about 2. In some embodiments, the portion 102 has a square cross-section with each side being about 12.5 inches. In some embodiments, the portion 102 can have a thickness from about 0.010 inches to about 5 inches or have an R-value measuring thermal insulation, such as from about 1 to about 35 or as appropriate for relevant fluid conduction or surroundings, as described herein. However, note that such configurations are just some of example configurations and other example configurations are possible as well.

In some embodiments, at least one side of the portion 102 includes at least one of a computer or a sensor. For example, at least two sides of the portion 102 can include the sensor, such as the sensor being configured to sense from the at least two sides. The computer can be coupled to the sensor, whether mechanically, electrically, or logically, whether locally or remotely, whether in a wired manner or a wireless manner. The computer can also avoid being coupled to the sensor, whether mechanically, electrically, or logically, whether locally or remotely. The computer can be powered via a power source, whether in a wired manner or a wireless manner, such as a battery, a renewable energy source, such as a wind turbine or a water turbine, or a photovoltaic cell. The computer can comprise the power source or be coupled thereto, whether locally or remotely. For example, the duct 100 comprises the power source, such as the power source being coupled to at least one of the portion 102, the portion 104, or at least one of the walls 106, with the power source comprising at least one of a battery, which can be rechargeable, or a wind turbine coupled to the battery, whether in a wired manner or a wireless manner, with the wind turbine being driven by the fluid being conducted through the duct 100, such as via a blade/foil of the wind turbine being at least partially inserted or exposed into the portion 104. The computer comprises a processor and a memory coupled to the processor. The computer can comprise a network communicator coupled to the processor, such as a receiver, a transmitter, or a transceiver. The computer can comprise at least one of an input device, such as a user input device, or an output device, such as a display.

The sensor can be active or passive, whether mechanical or electronic. The sensor is configured to detect or to respond to an input from a physical environment. For example, the input can be at least one of light, heat, motion, moisture, humidity, sound, electricity, pressure, or any other environmental aspect/parameter. The sensor can provide an output, such as a signal, which is sent, whether in a wired manner or a wireless manner, to an output device, such as a display. Whether additionally or alternatively, the sensor can comprise or be coupled to a transducer. The sensor can be powered via a power source, whether in a wired manner or a wireless manner, such as a battery, a renewable energy source, such as a wind turbine or a water turbine, or a photovoltaic cell. For example, the duct 100 comprises the power source, such as the power source being coupled to at least one of the portion 102, the portion 104, or at least one of the walls 106, with the power source comprising at least one of a battery, which can be rechargeable, or a wind turbine coupled to the battery, whether in a wired manner or a wireless manner, with the wind turbine being driven by the fluid being conducted through the duct 100, such as via a blade/foil of the wind turbine being at least partially inserted or exposed into the portion 104. For example, the sensor can be configured for communication, whether local or remote, whether in a wired or a wireless manner with another device, such as a mobile device, for instance, a tablet computer.

In some embodiments, the portion 102 includes an outer surface, which comprises a photovoltaic cell configured to receive light energy and create voltage or electric current thereby. Note that the photovoltaic cell can be configured to provide energy to at least one of the computer or the sensor. For example, the photovoltaic cell can provide energy to a battery, which in turn provides energy to at least one of the computer or the sensor. Also, note that the portion 102 can be positioned within another duct, a device, an apparatus, a machine, or a freestanding structure.

In some embodiments, the sensor can be at least one of acoustic, sound, or vibration based, such as at least one of a geophone, a hydrophone, or a microphone.

In some embodiments, the sensor can be a chemical sensor, such as at least one of an oxygen sensor, a carbon dioxide sensor, a carbon monoxide sensor, a hydrogen sensor, a catalytic bead sensor, a chemical field-effect transistor, an electrochemical gas sensor, an electronic nose, an electrolyte insulator semiconductor sensor, a fluorescent chloride sensor, a holographic sensor, a hydrocarbon dew point sensor, a hydrogen sulfide sensor, an infrared point sensor, a non-dispersive infrared sensor, a microwave chemistry sensor, a nitrogen oxide sensor, an olfactometer, an optode, an ozone monitor, a pellistor, a glass electrode, a potentiometric sensor, a smoke detector, or a zinc oxide nanorod sensor.

In some embodiments, the sensor can be at least one of electric current, electric potential, magnetic, or radio based, such as at least one of a current sensor, a Daly detector, an electroscope, a galvanometer, a hall effect sensor, a magnetic anomaly detector, a magnetometer, a micro-electromechanical (MEMS) magnetic field sensor, a metal detector, a radio direction finder, or a voltage detector.

In some embodiments, the sensor can be at least one of flow or fluid velocity based, such as at least one of an air flow meter, an anemometer, a flow sensor, a gas meter, a mass flow sensor, or a water meter.

In some embodiments, the sensor can be a radiation sensor, such as a Geiger counter.

In some embodiments, the sensor can be an altimeter or a depth gauge.

In some embodiments, the sensor can be at least one of position, angle, displacement, distance, speed, or acceleration based, such as at least one of a capacitive sensor, a photoelectric sensor, a shock or impact sensor, a tilt sensor, or an ultrasonic thickness sensor.

In some embodiments, the sensor can be at least one of optical, light, imaging, or photon based, such as at least one of an electro-optical sensor, a flame detector, an infrared sensor, a photo detector, a photoionization detector, a photo switch, a phototube, or a scintillometer.

In some embodiments, the sensor can be pressure based, such as at least one of a barograph, a barometer, a fluid density sensor, a piezometer, a fluid pressure sensor, a tactile sensor, or a contact sensor.

In some embodiments, the sensor can be at least one of force, density, or level based, such as at least one of a hydrometer, a force gauge, a level sensor, a load cell, a magnetic level gauge, a nuclear density gauge, a piezoelectric sensor, a strain gauge, or a viscometer.

In some embodiments, the sensor can be at least one of thermal, heat, or temperature based, such as at least one of a bolometer, a bimetallic strip, a calorimeter, a Gardon gauge/circular-foil gauge, a Golay cell, a heat flux sensor, an infrared thermometer, a quartz thermometer, a resistance thermometer, a silicon bandgap temperature sensor, a thermometer, a thermistor, a thermocouple, or a pyrometer.

In some embodiments, the sensor can be at least one of proximity or presence based, such as at least one of an alarm sensor, a motion detector, an occupancy sensor, a proximity sensor, a passive infrared sensor, a reed switch, or a glass or material integrity break sensor.

In some embodiments, the sensor can be at least one of a mold sensor, a mildew sensor, or a sensor configured to sense an environmental condition favorable to at least one of a mold, a mildew, or a fungus, such as disclosed in U.S. Pat. No. 7,382,269, which is fully incorporated by reference herein for all purposes.

Note that any sensor disclosed herein is an example and any other type of material property or physical environment sensor can be used, whether additionally or alternatively.

The portion 104 can be configured to conduct the forced fluid therethrough or for other uses, as described herein. The portion 104 can be of any size, length, width, depth, shape, volume, thickness, or cross-section, whether identical to or different from the portion 102. For example, the cross-section of the portion 104 can be triangular, circular, oval, rectangular, square, trapezoid or any other geometric shape. Also, for example, the portion 102 and the portion 104 can be identically shaped, such as both being square, or differently shaped from each other, such as one is circular and one is square. The portion 104 can be seamed or seamless, whether internally or externally, whether identical to or different from the portion 102. The portion 104 can include plastic, metal, wood, glass, stone, rubber, or any other material, whether biodegradable, flame-retardant, bacteria-resistant, or leak-proof, whether internally or externally, whether identical to or different from the portion 102. The portion 104 can extend longitudinally in a rectilinear, arcuate, sinusoidal, zigzag, or any other manner, whether identical to or different from the portion 102. The portion 104 can be of any color, such as white, black, blue, red, orange, purple, or others, whether internally or externally, whether identical or different from the portion 102. The portion 104 can be reflective or non-reflective, whether internally or externally, whether identical to or different from the portion 102. The portion 104 can define an aperture, whether internally or externally, whether identical to or different from the portion 102, for use with a fastener, such as a screw, whether identical to or different from the portion 102. The portion 104 can be rigid or flexible, whether identical to or different from the portion 102. The portion 104 can have an R-value measuring thermal insulation equal to, less than, or greater than the portion 102. The portion 102 and the portion 104 can be can be concentric with each other or non-concentric with each other. The portion 104 can be recessed with respect to the portion 102 or non-recessed with respect to the portion 102. The portion 104 can be transparent, translucent, or opaque, whether identical to or different from the portion 102. The portion 104 can be solid or perforated, whether identical to or different from the portion 102. The portion 104 can define a lattice or a mesh. In some embodiments, the portion 104 is about ⅛ inch thick, about 4 feet long and has an R-value measuring thermal insulation of about 0.5. In some embodiments, the portion 104 has a square cross-section with each side being about 10 inches. In some embodiments, the portion 104 can have a thickness from about 0.010 inches to about 5 inches or have an R-value measuring thermal insulation, such as from about 1 to about 35 or as appropriate for relevant fluid conduction or surroundings, as described herein. However, note that such configurations are just some of example configurations and other example configurations are possible as well.

In some embodiments, at least one side of the portion 104 includes at least one of a computer or a sensor, whether identical to or different from at least one of the computer or the sensor of the portion 102 in any functional, operational, positional, or structural characteristic/aspect/property/manner. For example, at least two sides of the portion 104 can include the sensor, such as the sensor being configured to sense from the at least two sides. For the portion 104, the computer can be coupled to the sensor, whether mechanically, electrically, or logically, whether locally or remotely, whether in a wired manner or a wireless manner. The computer can also avoid being coupled to the sensor, whether mechanically, electrically, or logically, whether locally or remotely. The computer can be powered via a power source, whether in a wired manner or a wireless manner, such as a battery, a renewable energy source, such as a wind turbine or a water turbine, or a photovoltaic cell. The computer can comprise the power source or be coupled thereto, whether locally or remotely. For example, the duct 100 comprises the power source, such as the power source being coupled to at least one of the portion 102, the portion 104, or at least one of the walls 106, with the power source comprising at least one of a battery, which can be rechargeable, or a wind turbine coupled to the battery, whether in a wired manner or a wireless manner, with the wind turbine being driven by the fluid being conducted through the duct 100, such as via a blade/foil of the wind turbine being at least partially inserted or exposed into the portion 104. The computer comprises a processor and a memory coupled to the processor. The computer can comprise a network communicator coupled to the processor, such as a receiver, a transmitter, or a transceiver. The computer can comprise at least one of an input device, such as a user input device, or an output device, such as a display.

For the portion 104, the sensor can be active or passive, whether mechanical or electronic. The sensor is configured to detect or to respond to an input from a physical environment. For example, the input can be at least one of light, heat, motion, moisture, humidity, sound, electricity, pressure, or any other environmental aspect/parameter. The sensor can provide an output, such as a signal, which is sent, whether in a wired manner or a wireless manner, to an output device, such as a display. Whether additionally or alternatively, the sensor can comprise or be coupled to a transducer. The sensor can be powered via a power source, whether in a wired manner or a wireless manner, such as a battery, a renewable energy source, such as a wind turbine or a water turbine, or a photovoltaic cell. For example, the duct 100 comprises the power source, such as the power source being coupled to at least one of the portion 102, the portion 104, or at least one of the walls 106, with the power source comprising at least one of a battery, which can be rechargeable, or a wind turbine coupled to the battery, whether in a wired manner or a wireless manner, with the wind turbine being driven by the fluid being conducted through the duct 100, such as via a blade/foil of the wind turbine being at least partially inserted or exposed into the portion 104. For example, the sensor can be configured for communication, whether local or remote, whether in a wired or a wireless manner with another device, such as a mobile device, for instance, a tablet computer.

In some embodiments, the portion 104 includes an outer surface, which comprises a photovoltaic cell configured to receive light energy and create voltage or electric current thereby. For example, the portion 102 can be at least one of polarized, transparent, or translucent such that the photovoltaic cell positioned on the outer surface of the portion 104 is able to receive light to perform photovoltaic effect. Note that the photovoltaic cell can be configured to provide energy to at least one of the computer or the sensor. For example, the photovoltaic cell can provide energy to a battery, which in turn provides energy to at least one of the computer or the sensor.

In some embodiments, the sensor can be at least one of acoustic, sound, or vibration based, such as at least one of a geophone, a hydrophone, or a microphone.

In some embodiments, the sensor can be a chemical sensor, such as at least one of an oxygen sensor, a carbon dioxide sensor, a carbon monoxide sensor, a hydrogen sensor, a catalytic bead sensor, a chemical field-effect transistor, an electrochemical gas sensor, an electronic nose, an electrolyte insulator semiconductor sensor, a fluorescent chloride sensor, a holographic sensor, a hydrocarbon dew point sensor, a hydrogen sulfide sensor, an infrared point sensor, a non-dispersive infrared sensor, a microwave chemistry sensor, a nitrogen oxide sensor, an olfactometer, an optode, an ozone monitor, a pellistor, a glass electrode, a potentiometric sensor, a smoke detector, or a zinc oxide nanorod sensor.

In some embodiments, the sensor can be at least one of electric current, electric potential, magnetic, or radio based, such as at least one of a current sensor, a Daly detector, an electroscope, a galvanometer, a hall effect sensor, a magnetic anomaly detector, a magnetometer, a micro-electromechanical (MEMS) magnetic field sensor, a metal detector, a radio direction finder, or a voltage detector.

In some embodiments, the sensor can be at least one of flow or fluid velocity based, such as at least one of an air flow meter, an anemometer, a flow sensor, a gas meter, a mass flow sensor, or a water meter.

In some embodiments, the sensor can be a radiation sensor, such as a Geiger counter.

In some embodiments, the sensor can be an altimeter or a depth gauge.

In some embodiments, the sensor can be at least one of position, angle, displacement, distance, speed, or acceleration based, such as at least one of a capacitive sensor, a photoelectric sensor, a shock or impact sensor, a tilt sensor, or an ultrasonic thickness sensor.

In some embodiments, the sensor can be at least one of optical, light, imaging, or photon based, such as at least one of an electro-optical sensor, a flame detector, an infrared sensor, a photo detector, a photoionization detector, a photo switch, a phototube, or a scintillometer.

In some embodiments, the sensor can be pressure based, such as at least one of a barograph, a barometer, a fluid density sensor, a piezometer, a fluid pressure sensor, a tactile sensor, or a contact sensor.

In some embodiments, the sensor can be at least one of force, density, or level based, such as at least one of a hydrometer, a force gauge, a level sensor, a load cell, a magnetic level gauge, a nuclear density gauge, a piezoelectric sensor, a strain gauge, or a viscometer.

In some embodiments, the sensor can be at least one of thermal, heat, or temperature based, such as at least one of a bolometer, a bimetallic strip, a calorimeter, a Gardon gauge/circular-foil gauge, a Golay cell, a heat flux sensor, an infrared thermometer, a quartz thermometer, a resistance thermometer, a silicon bandgap temperature sensor, a thermometer, a thermistor, a thermocouple, or a pyrometer.

In some embodiments, the sensor can be at least one of proximity or presence based, such as at least one of an alarm sensor, a motion detector, an occupancy sensor, a proximity sensor, a passive infrared sensor, a reed switch, or a glass or material integrity break sensor.

In some embodiments, the sensor can be at least one of a mold sensor, a mildew sensor, or a sensor configured to sense an environmental condition favorable to at least one of a mold, a mildew, or a fungus, such as disclosed in U.S. Pat. No. 7,382,269, which is fully incorporated by reference herein for all purposes.

Note that any sensor disclosed herein is an example and any other type of material property or physical environment sensor can be used, whether additionally or alternatively. Further, note that any sensor with respect to the portion 102 can be identical to or different from any sensor with respect to the portion 104 in any functional, structural, operational, or positional characteristic/aspect/property/manner.

The walls 106 can be of any size, length, width, depth, shape, volume, thickness, or cross-section, such as triangular, circular, oval, rectangular, square, trapezoid or any other geometric shape, whether identical or different from each other. The walls 106 can include plastic, metal, wood, glass, stone, rubber, or any other material, whether biodegradable, flame-retardant, bacteria-resistant, or leak-proof, whether internally or externally, whether identical to or different from each other. The walls 106 can extend longitudinally in a rectilinear, arcuate, sinusoidal, zigzag, or any other manner, whether identical or different from each other. The walls 106 can be of any color, such as white, black, blue, red, orange, purple, or others, whether internally or externally, whether identical to or different from each other. The walls 106 can be reflective or non-reflective, whether internally or externally, whether identical to or different from each other. The walls 106 can define an aperture, whether identical to or different from each other, whether internally or externally, for use with a fastener, such as a screw, whether identical to or different from each other. The walls 106 can be rigid or flexible, whether identical to or different from each other. The walls 106 can be transparent, translucent, or opaque, whether identical to or different from each other. The walls 106 can be solid or perforated, whether identical to or different from each other. At least one of the walls 106 can define a lattice or a mesh. In some embodiments, at least one of the walls 106 is equal, longer or shorter longitudinally than at least one of the portion 102 and the portion 104. In some embodiments, at least one of the walls 106 extends outward past an end of at least one of the portion 102 and the portion 104. In some embodiments, at least one of the walls 106 starts not immediately from an end portion of at least one of the portion 102 and the portion 104, such as via recessing with respect thereto. In some embodiments, at least one of the walls 106 is segmented longitudinally with open spaces therebetween. In some embodiments, at least one side of at least one of the portion 102 and the portion 104 includes at least one of the walls 106. In some embodiments, at least one of the walls 106 extends from or between a corner of at least one of the portion 102 and the portion 104. In some embodiments, at least one of the walls 106 is a column. In some embodiments, at least one of the walls 106 can have a thickness from about 0.010 inches to about 5 inches or have an R-value measuring thermal insulation, such as from about 1 to about 35 or as appropriate for relevant fluid conduction or surroundings, as described herein. However, note that such configurations are just some of example configurations and other example configurations are possible as well.

In some embodiments, at least one side of at least one of the walls 106 includes at least one of a computer or a sensor, whether identical to or different from at least one of the computer or the sensor of the portion 102 or at least one of the computer or the sensor of the portion 104 in any functional, operational, positional, or structural characteristic/aspect/property/manner. For example, at least two sides of the of at least one of the walls 106 can include the sensor, such as the sensor being configured to sense from the at least two sides. For at least one of the walls 106, the computer can be coupled to the sensor, whether mechanically, electrically, or logically, whether locally or remotely, whether in a wired manner or a wireless manner. The computer can also avoid being coupled to the sensor, whether mechanically, electrically, or logically, whether locally or remotely. The computer can be powered via a power source, whether in a wired manner or a wireless manner, such as a battery, a renewable energy source, such as a wind turbine or a water turbine, or a photovoltaic cell. The computer can comprise the power source or be coupled thereto, whether locally or remotely. For example, the duct 100 comprises the power source, such as the power source being coupled to at least one of the portion 102, the portion 104, or at least one of the walls 106, with the power source comprising at least one of a battery, which can be rechargeable, or a wind turbine coupled to the battery, whether in a wired manner or a wireless manner, with the wind turbine being driven by the fluid being conducted through the duct 100, such as via a blade/foil of the wind turbine being at least partially inserted or exposed into the portion 104. The computer comprises a processor and a memory coupled to the processor. The computer can comprise a network communicator coupled to the processor, such as a receiver, a transmitter, or a transceiver. The computer can comprise at least one of an input device, such as a user input device, or an output device, such as a display.

For at least one of the walls 106, the sensor can be active or passive, whether mechanical or electronic. The sensor is configured to detect or to respond to an input from a physical environment. For example, the input can be at least one of light, heat, motion, moisture, humidity, sound, electricity, pressure, or any other environmental aspect/parameter. The sensor can provide an output, such as a signal, which is sent, whether in a wired manner or a wireless manner, to an output device, such as a display. Whether additionally or alternatively, the sensor can comprise or be coupled to a transducer. The sensor can be powered via a power source, whether in a wired manner or a wireless manner, such as a battery, a renewable energy source, such as a wind turbine or a water turbine, or a photovoltaic cell. For example, the duct 100 comprises the power source, such as the power source being coupled to at least one of the portion 102, the portion 104, or at least one of the walls 106, with the power source comprising at least one of a battery, which can be rechargeable, or a wind turbine coupled to the battery, whether in a wired manner or a wireless manner, with the wind turbine being driven by the fluid being conducted through the duct 100, such as via a blade/foil of the wind turbine being at least partially inserted or exposed into the portion 104. For example, the sensor can be configured for communication, whether local or remote, whether in a wired or a wireless manner with another device, such as a mobile device, for instance, a tablet computer.

In some embodiments, at least one of the walls 106 includes a surface, such as outer, which comprises a photovoltaic cell configured to receive light energy and create voltage or electric current thereby. For example, the portion 102 can be at least one of polarized, transparent, or translucent such that the photovoltaic cell positioned on the surface of at least one of the walls 106 is able to receive light to perform photovoltaic effect. Note that the photovoltaic cell can be configured to provide energy to at least one of the computer or the sensor. For example, the photovoltaic cell can provide energy to a battery, which in turn provides energy to at least one of the computer or the sensor.

In some embodiments, the sensor can be at least one of acoustic, sound, or vibration based, such as at least one of a geophone, a hydrophone, or a microphone.

In some embodiments, the sensor can be a chemical sensor, such as at least one of an oxygen sensor, a carbon dioxide sensor, a carbon monoxide sensor, a hydrogen sensor, a catalytic bead sensor, a chemical field-effect transistor, an electrochemical gas sensor, an electronic nose, an electrolyte insulator semiconductor sensor, a fluorescent chloride sensor, a holographic sensor, a hydrocarbon dew point sensor, a hydrogen sulfide sensor, an infrared point sensor, a non-dispersive infrared sensor, a microwave chemistry sensor, a nitrogen oxide sensor, an olfactometer, an optode, an ozone monitor, a pellistor, a glass electrode, a potentiometric sensor, a smoke detector, or a zinc oxide nanorod sensor.

In some embodiments, the sensor can be at least one of electric current, electric potential, magnetic, or radio based, such as at least one of a current sensor, a Daly detector, an electroscope, a galvanometer, a hall effect sensor, a magnetic anomaly detector, a magnetometer, a micro-electromechanical (MEMS) magnetic field sensor, a metal detector, a radio direction finder, or a voltage detector.

In some embodiments, the sensor can be at least one of flow or fluid velocity based, such as at least one of an air flow meter, an anemometer, a flow sensor, a gas meter, a mass flow sensor, or a water meter.

In some embodiments, the sensor can be a radiation sensor, such as a Geiger counter.

In some embodiments, the sensor can be an altimeter or a depth gauge.

In some embodiments, the sensor can be at least one of position, angle, displacement, distance, speed, or acceleration based, such as at least one of a capacitive sensor, a photoelectric sensor, a shock or impact sensor, a tilt sensor, or an ultrasonic thickness sensor.

In some embodiments, the sensor can be at least one of optical, light, imaging, or photon based, such as at least one of an electro-optical sensor, a flame detector, an infrared sensor, a photo detector, a photoionization detector, a photo switch, a phototube, or a scintillometer.

In some embodiments, the sensor can be pressure based, such as at least one of a barograph, a barometer, a fluid density sensor, a piezometer, a fluid pressure sensor, a tactile sensor, or a contact sensor.

In some embodiments, the sensor can be at least one of force, density, or level based, such as at least one of a hydrometer, a force gauge, a level sensor, a load cell, a magnetic level gauge, a nuclear density gauge, a piezoelectric sensor, a strain gauge, or a viscometer.

In some embodiments, the sensor can be at least one of thermal, heat, or temperature based, such as at least one of a bolometer, a bimetallic strip, a calorimeter, a Gardon gauge/circular-foil gauge, a Golay cell, a heat flux sensor, an infrared thermometer, a quartz thermometer, a resistance thermometer, a silicon bandgap temperature sensor, a thermometer, a thermistor, a thermocouple, or a pyrometer.

In some embodiments, the sensor can be at least one of proximity or presence based, such as at least one of an alarm sensor, a motion detector, an occupancy sensor, a proximity sensor, a passive infrared sensor, a reed switch, or a glass or material integrity break sensor.

In some embodiments, the sensor can be at least one of a mold sensor, a mildew sensor, or a sensor configured to sense an environmental condition favorable to at least one of a mold, a mildew, or a fungus, such as disclosed in U.S. Pat. No. 7,382,269, which is fully incorporated by reference herein for all purposes.

Note that any sensor disclosed herein is an example and any other type of material property or physical environment sensor can be used, whether additionally or alternatively. Further, note that any sensor with respect to at least one of the walls 106 can be identical to or different from any sensor with respect to at least one of the portion 102 or the portion 104 in any functional, structural, operational, or positional characteristic/aspect/property/manner.

The channels 108 can be of any size, length, width, depth, shape, volume, thickness, or cross-section, such as triangular, circular, oval, rectangular, square, trapezoid or any other geometric shape, whether identical or different from each other. The channels 108 can extend longitudinally in a rectilinear, arcuate, sinusoidal, zigzag, or any other manner, whether identical or different from each other, whether parallel or non-parallel. The channels 108 can be in fluid communication with each other, such as through at least one of the walls 106. In some embodiments, at least one of the channels 108 can be closed from at least one end. In some embodiments, at least one of the channels 108 can be open from at least one end. In some embodiments, at least one of the channels 108 contains a first open end, a second open end, and a partition extending between two of the walls 106 and the portion 102 and the portion 104 such that the first end is unable to fluidly communicate with the second end. Note that such partition can be assembled with or unitary to at least one of the portion 102, the portion 104, or at least one of the walls 106. In some embodiments, at least one of the channels 108 is configured to conduct the forced fluid therethrough or for other uses, as described herein.

At least one of the channels 108 is configured to contain an insulation layer, such as a thermal insulation foam, an electrical insulation foam, a moisture insulation foam, or a non-foam based material, such as a gel. When at least two of the channels 108 contain at least two insulation layers, then such insulation layers can be identical to or different from each other in structure, function, material, chemical constituency, density, volume, or any other measurable characteristic. In some embodiments, the insulation layer can include polyurethane. In some embodiments, the insulation layer can be phenolic. In some embodiments, the insulation layer can include or be adhesive, one at least one side. In some embodiments, the insulation layer can be biodegradable, flame-retardant, bacteria-resistant, or leak-proof. In some embodiments, the insulation layer can include a plurality of particles, which can include plastic, metal, wood, glass, stone, rubber, or any other material, whether, whether internally or externally, whether identical to or different from each other. In some embodiments, the insulation layer can have an R-value measuring thermal insulation of at least about 7. However, the R-value of insulation layer can be lower as well. In some embodiments, the insulation layer can be or include a spray foam filler. In some embodiments, the insulation layer is about 1.25 inch thick, about 4 feet long, and has the R-value of about 7.5. In some embodiments, at least one of the channels 108 has a closed end or a partition such that the insulation layer is not visible when viewed from a front of the duct 100. In some embodiments, the portion 102, the portion 104, at least one of the walls 106, and the insulation layer have a combined R-value measuring thermal insulation of at least about 8. Such R-value enables the duct 100 to be compliant with at least one building code. However, note that other combined insulation ratings are possible as well, whether for compliance with building codes or other legal codes or environmental aspects, such as the combined insulation R-value of at most about 8, such as between 0.1 and 8. In some embodiments, the insulation layer has the R-value from about 0.5 to about 35 or as appropriate for relevant fluid conduction or surroundings, as described herein. In some embodiments, the walls 106 are absent such that a single channel 108 is defined between the portion 102 and the portion 104. The layer is interposed/positioned between the portion 102 and the portion 104 in the single channel 108, whether directly or indirectly contacting at least one of the portion 102 and the portion 104, whether spanning between ends of the duct 100 fully or less than such span, such as via being recessed with respect to an end of at least one of the portion 102 and the portion 104. For example, the single channel 108 can be shaped in accordance with a difference along a vertical axis between the portion 102 and the portion 104, whether uniform or varying longitudinally, radially, diagonally, or in other directions. The portion 102 is coupled to the layer, such as via adhering, bonding, sonic sealing, or ultrasonic welding, or other coupling methodologies. The portion 104 is coupled to the layer, such as via adhering, bonding, sonic sealing, or ultrasonic welding, or other coupling methodologies. Note that the portion 102 can couple to the layer in a first manner and the portion 104 can couple to the layer in a second manner, whether identical to the first manner or different from the first manner in structure or function. For example, the portion 102 includes an inner surface which adheres to the layer and the portion 104 includes an outer surface which bonds to the layer.

In some embodiments, any side of at least one of the portion 102, the portion 104, or at least one of the walls 106 can comprise a fluid heater powered by a power source, as disclosed herein. The fluid heater can comprise at least one of a liquid heater or a gas heater. The fluid heater is able to apply heat to the fluid being conducted through the duct 100, such as via a heating element, whether through the portion 104 or through at least one of the channels 108. For example, the liquid heater can raise a thermal temperature of a water conducted within the duct 100 from an ambient temperature by about 1 degree Celsius, such as within 15 minutes, such as to reduce a chance of freezing or at least one of potentially damaging the duct 100, outwardly stretching the duct 100, reducing flow within the duct 100, or changing a structural integrity of the duct 100, such as via outward expansion. For example, the power source can comprise a battery, a mains electricity source, or a renewable power source, whether local or remote from the duct 100, whether attached to the duct 100 or not attached to the duct 100, such as mechanically. In some embodiments, the fluid heater can be used to apply heat to an external side of the portion 102 to effectively prevent snow or ice build up on the external side of the portion 102, such as when placed outside of a building or used in refrigeration.

In one method of operation, the duct 100 comprises a sensor configured to sense for a fluid being conducted through the duct 100, with the fluid comprising an unsafe or dangerous material to mammals, whether directly or indirectly, such as humans, animals, birds, fish, or insects. For example, the unsafe or dangerous material can comprise a chemical weapon agent or a gas, such as smoke, carbon monoxide, sarin, chlorine, tabun, or any other dangerous, radioactive, or lethal gaseous or liquid substance, either alone or in combination with one or more of fluids. For example, the unsafe or dangerous material can comprise a harassing agent, such as a tear agent, a vomiting agent, a malodorant. For example, the unsafe or dangerous material can comprise a psychological agent, such as Phencyclidine. For example, the unsafe or dangerous material can comprise a lethal agent, such as a blister agent, such as a vesicant or a urticant. For example, the unsafe or dangerous material can comprise a blood agent, a choking agent, or a nerve agent. In other methods of operation, whether additionally or alternatively, the duct 100 comprises a sensor configured to sense for a structural or functional integrity of the duct 100 or lack thereof. For example, the sensor can sense for at least one of the portion 102, the portion 104, at least one of the walls 106, or the insulation layer being structurally or chemically sound or lack thereof, such as not broken, not cracked, not tampered with, sufficiently insulated, or other structurally sound property. In other methods of operation, whether additionally or alternatively, the duct 100 comprises a sensor configured to sense for an inefficient, unsafe, or dangerous amount, pressure, viscosity, odor, or any other fluid aspect/characteristic of a fluid being conducted through the duct 100, such as thermal energy. In other methods of operation, the duct 100 comprises a sensor configured to sense ambient or environmental surroundings, such as weather, radioactivity, mammalian movement, or natural disasters, such as flooding, forest fires, volcanoes, earthquakes, hurricanes, tornadoes, or others.

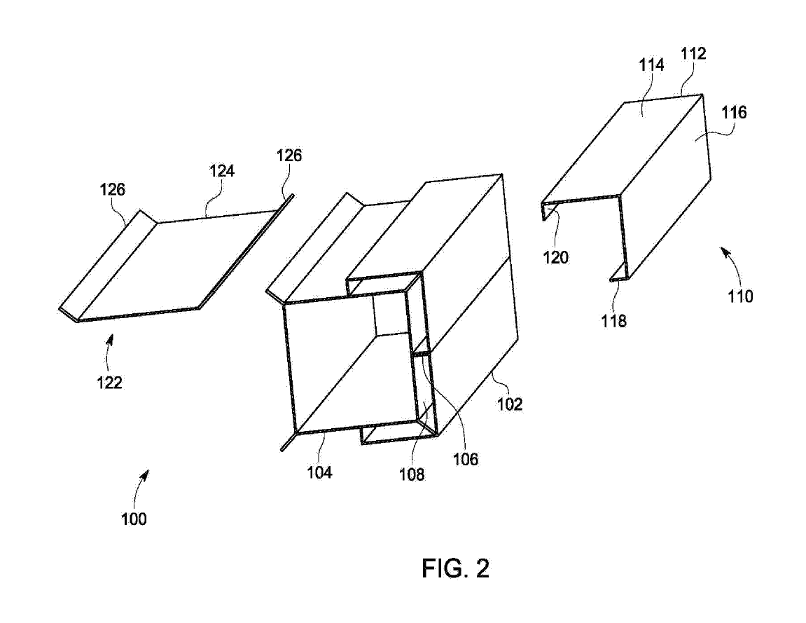

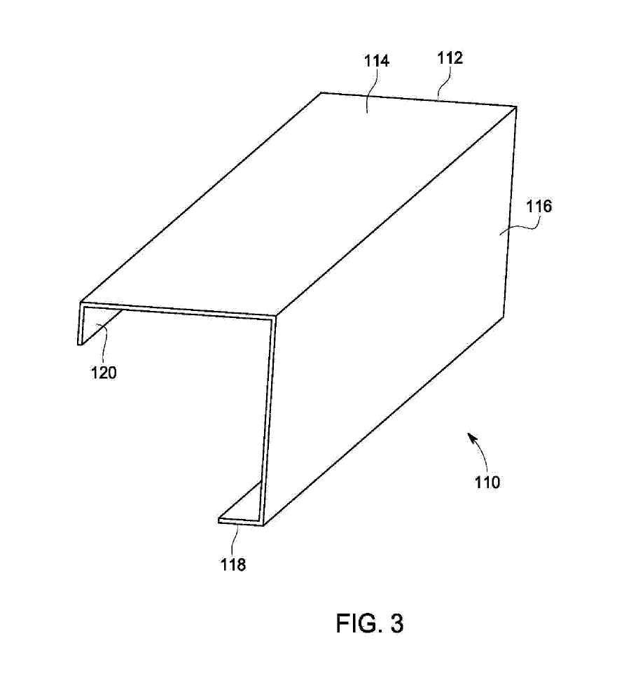

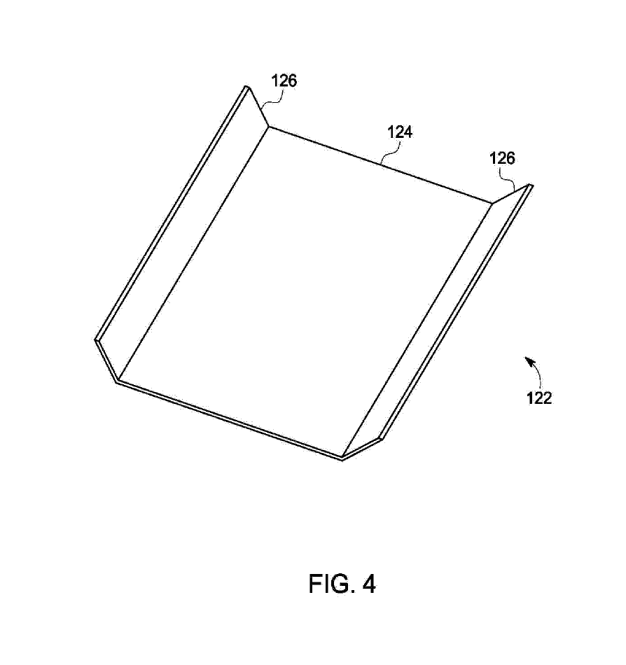

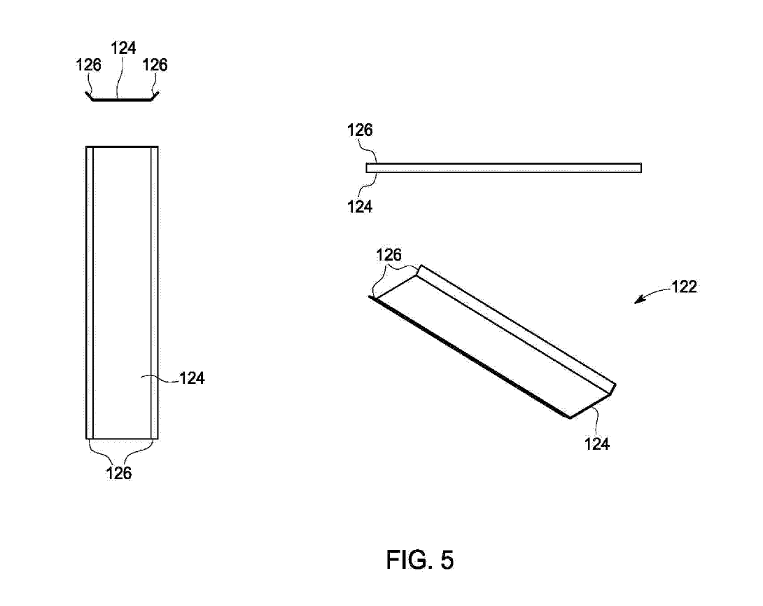

FIG. 2 shows an exploded view of a duct according to the present disclosure. FIG. 3 shows a perspective view of a segment of an outer portion of a duct according to the present disclosure. FIG. 4 shows a perspective view of a segment of an inner portion of a duct according to the present disclosure. FIG. 5 shows a top view, a profile view, and a perspective view of a segment of an inner portion of a duct according to the present disclosure. Some elements of this figure are described above. Thus, same reference characters identify identical and/or like components described above and any repetitive detailed description thereof will hereinafter be omitted or simplified in order to avoid complication.

The portion 102 is defined via a set of segments 110 positioned immediately adjacent to each other. The segments 110 can be coupled to each other, such as via fastening, adhering, mating, interlocking, clamping, hook-and-looping, magnetizing, or other coupling manners. In some embodiments, the segments 110 are not coupled to each other.

Each of the segments 110 includes an L-shaped body 112 defined via a base portion 114 and a wall portion 116. The portion 114 includes a first winglet 120 extending therefrom. The portion 116 includes a second winglet 118 extending therefrom.

The portion 114 and the portion 116 are unitary, such as one piece. In some embodiments, the portion 114 and the portion 116 are an assembly, such as via fastening, adhering, mating, interlocking, clamping, hook-and-looping, magnetizing, or other methods of assembly. The portion 114 and the portion 116 are in an orthogonal relationship with each other. However, arcuate, obtuse or acute relationships are possible as well.

The portion 114 and the winglet 120 are unitary, such as one piece. In some embodiments, the portion 114 and the winglet 120 are an assembly, such as via fastening, adhering, mating, interlocking, clamping, hook-and-looping, magnetizing, or other methods of assembly. The portion 114 and the winglet 120 are in an orthogonal relationship with each other. However, arcuate, obtuse or acute relationships are possible as well, whether exposed to one surface of the portion 114 or different surfaces of the portion 114.

The portion 116 and the winglet 118 are unitary, such as one piece. In some embodiments, the portion 116 and the winglet 118 are an assembly, such as via fastening, adhering, mating, interlocking, clamping, hook-and-looping, magnetizing, or other methods of assembly. The portion 116 and the winglet 118 are in an orthogonal relationship with each other. However, arcuate, obtuse or acute relationships are possible as well, whether exposed to one surface of the portion 116 or different surfaces of the portion 116.

The winglet 118 and the winglet 120 are in an orthogonal relationship with each other. However, obtuse or acute relationships are possible as well. For example, at least one of the winglet 188 and the winglet 120 is shaped as an arc, whether concave or convex toward at least one of the portion 114 and the portion 116, while extending longitudinally along the at least one of the portion 114 and the portion 116. Note that the winglet 118 and the winglet 120 can be identical or different from each other in structure, function, material, chemical composition, shape, geometric measurement or any other quantitative characteristic.

At least one of the portion 114, the portion 116, the portion 118, and the portion 120 can be of any size, length, width, depth, shape, volume, thickness, or cross-section. At least one of the portion 114, the portion 116, the portion 118, and the portion 120 can include plastic, metal, wood, glass, stone, rubber, or any other material, whether biodegradable, flame-retardant, bacteria-resistant, or leak-proof, whether internally or externally. At least one of the portion 114, the portion 116, the portion 118, and the portion 120 can extend longitudinally in a rectilinear, arcuate, sinusoidal, zigzag, or any other manner. At least one of the portion 114, the portion 116, the portion 118, and the portion 120 can be of any color, such as white, black, blue, red, orange, purple, or others, whether internally or externally. At least one of the portion 114, the portion 116, the portion 118, and the portion 120 can be reflective or non-reflective, whether internally or externally. At least one of the portion 114, the portion 116, the portion 118, and the portion 120 can define an aperture, whether internally or externally, for use with a fastener, such as a screw. At least one of the portion 114, the portion 116, the portion 118, and the portion 120 can be rigid or flexible. At least one of the portion 114, the portion 116, the portion 118, and the portion 120 can be transparent, translucent, or opaque. At least one of the portion 114, the portion 116, the portion 118, and the portion 120 can be solid or perforated. In some embodiments, at least one of the portion 114, the portion 116, the portion 118, and the portion 120 has an R-value measuring thermal insulation of about 2.

In some embodiments, the winglets 118 or the winglets 120 of the segments 110, which are immediately adjacent to each other, can be coupled to each other, such as via fastening, adhering, mating, interlocking, clamping, hook-and-looping, magnetizing, or other coupling manners. If a seam is formed thereby, then such seam can be left alone or sealed, such as with a sealant, which can be insulating, adhesive, biodegradable, flame-retardant, bacteria-resistant, or leak-proof. In some embodiments, the winglets 118 of the segments 110, which are immediately adjacent to each other, can be not coupled to each other. In some embodiments, at least one of the segments 110 is shaped as at least one of a U-shape, a C-shape, a V-shape, an E-shape, an H-shape, an F-shape, a T-shape, and a Y-shape. In some embodiments, at least one of the segments 110 is shaped as an arc. In some embodiments, the portion 102 defined via the segments 110 can be of any size, length, width, depth, shape, volume, thickness, or cross-section, such as triangular, circular, oval, rectangular, square, trapezoid or any other geometric shape. The portion 102 can be seamed or seamless, whether internally or externally. The portion 102 can extend longitudinally in a rectilinear, arcuate, sinusoidal, zigzag, or any other manner.

The portion 104 is defined via a set of segments 122 positioned immediately adjacent to each other. The segments 122 can be coupled to each other, such as via fastening, adhering, mating, interlocking, clamping, hook-and-looping, magnetizing, or other coupling manners. In some embodiments, the segments 122 are not coupled to each other. Resultantly, the portion 104 can be configured to conduct the forced fluid therethrough or for other uses, as described herein. The portion 104 can be of any size, length, width, depth, shape, volume, thickness, or cross-section, whether identical to or different from the portion 102. For example, the cross-section of the portion 104 can be triangular, circular, oval, rectangular, square, trapezoid or any other geometric shape. Also, for example, the portion 102 and the portion 104 can be identically shaped, such as both being square, or differently shaped from each other, such as one is circular and one is square.

Each of the segments 122 includes a plate 124 and a pair of wings 126 extending from the plate 124 opposite each other. The plate 124 and at least one of the wings 126 are unitary, such as one piece. In some embodiments, the plate 124 and at least one of the wings 126 are an assembly, such as via fastening, adhering, mating, interlocking, clamping, hook-and-looping, magnetizing, or other methods of assembly. The wings 126 are in an obtuse relationship with the plate 124, such as diverging from each other. However, arcuate, orthogonal, or acute relationships are possible as well, whether exposed to one surface of the plate 124 or different surfaces of the plate 124, such as converging to each other. Note that the wings 126 can be identical or different from each other in structure, function, material, chemical composition, shape, geometric measurement or any other quantitative characteristic.

At least one of the plate 124 and at least one of the wings 126 can be of any size, length, width, depth, shape, volume, thickness, or cross-section. At least one of the plate 124 and at least one of the wings 126 can include plastic, metal, wood, glass, stone, rubber, or any other material, whether biodegradable, flame-retardant, bacteria-resistant, or leak-proof, whether internally or externally. At least one of the plate 124 and at least one of the wings 126 can extend longitudinally in a rectilinear, arcuate, sinusoidal, zigzag, or any other manner. At least one of the plate 124 and at least one of the wings 126 can be of any color, such as white, black, blue, red, orange, purple, or others, whether internally or externally. At least one of the plate 124 and at least one of the wings 126 can be reflective or non-reflective, whether internally or externally. At least one of the plate 124 and at least one of the wings 126 can define an aperture, whether internally or externally, for use with a fastener, such as a screw. At least one of the plate 124 and at least one of the wings 126 can be rigid or flexible. At least one of the plate 124 and at least one of the wings 126 can be transparent, translucent, or opaque. At least one of the plate 124 and at least one of the wings 126 can be solid or perforated. In some embodiments, at least one of the plate 124 and at least one of the wings 126 has an R-value measuring thermal insulation of about 0.5.

In some embodiments, the wings 126 of the segments 122, which are immediately adjacent to each other, can be coupled to each other, such as via fastening, adhering, mating, interlocking, clamping, hook-and-looping, magnetizing, or other coupling manners. If a seam is formed thereby, then such seam can be left alone or sealed, such as with a sealant, which can be insulating, adhesive, biodegradable, flame-retardant, bacteria-resistant, or leak-proof. In some embodiments, the wings 126 of the segments 122, which are immediately adjacent to each other, can be not coupled to each other. In some embodiments, the portion 104 defined via the segments 122 can be of any size, length, width, depth, shape, volume, thickness, or cross-section, such as triangular, circular, oval, rectangular, square, trapezoid or any other geometric shape. The portion 104 can be seamed or seamless, whether internally or externally. The portion 104 can extend longitudinally in a rectilinear, arcuate, sinusoidal, zigzag, or any other manner.

Note that the wings 126 of the segments 122, which are immediately adjacent to each other, extend into an inner corner of the segment 110 defined by the portion 114 and the portion 116, while the winglet 120 spans between the base 114 and the plate 124 and the winglet 118 spans between the portion 116 and the plate 124 of the immediately adjacent segment 122. Such configuration defines the channels 108 of the duct 100. Note that the channels 108 can be of any size, length, width, depth, shape, volume, thickness, or cross-section, such as triangular, circular, oval, rectangular, square, trapezoid or any other geometric shape, whether identical or different from each other. The channels 108 can extend longitudinally in a rectilinear, arcuate, sinusoidal, zigzag, or any other manner, whether identical or different from each other. The channels 108 can be in fluid communication with each other, such as through at least one of the walls 106. In some embodiments, at least one of the channels 108 can be closed from at least one end. In some embodiments, at least one of the channels 108 can be open from at least one end. In some embodiments, at least one of the channels 108 contains a first open end, a second open end, and a partition extending between two of the walls 106 and the portion 102 and the portion 104 such that the first end is unable to fluidly communicate with the second end. Note that such partition can be assembled with or unitary to at least one of the portion 102, the portion 104, or at least one of the walls 106. In some embodiments, at least one of the channels 108 is configured to conduct the forced fluid therethrough or for other uses, as described herein.

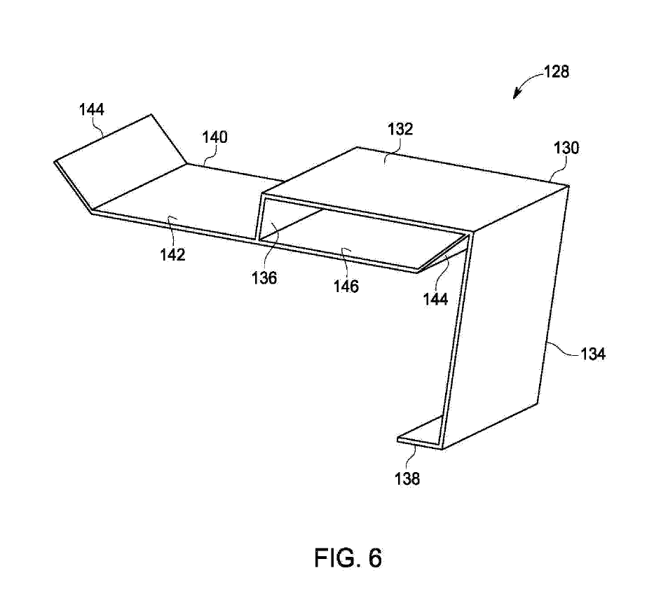

FIG. 6 shows a perspective view of a segment of a duct according to the present disclosure. Some elements of this figure are described above. Thus, same reference characters identify identical and/or like components described above and any repetitive detailed description thereof will hereinafter be omitted or simplified in order to avoid complication.

The duct 100 can be defined via a set of segments 128. Each of the segments 128 is a unitary body shaped as a combination of the segment 110 and the segment 122, in any combinatory manner, as described herein. For example, the duct 100 can be defined via at least one of the segment 110, the segment 122, and the segment 128, in any combinatory manner.

Each of the segments 128 includes an L-shaped body 130, such as the body 112, defined via a base portion 132, such as the portion 114, and a wall portion 134, such as the portion 116. The portion 132 has a winglet 136, such as the winglet 120, extending therefrom. The portion 134 has a winglet 138, such as the winglet 118, extending therefrom.

Each of the segments 128 includes a body 140 which includes a plate 142, such as the plate 124, and a pair of wings 144, such as the wings 126, extending therefrom, while opposing each other. The winglet 136 extends along the plate 142 between the wings 144 such that the winglet 136, one of the wings 144, the portion 132 and the plate 142 define a channel 146 thereby, such as one of the channels 108.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

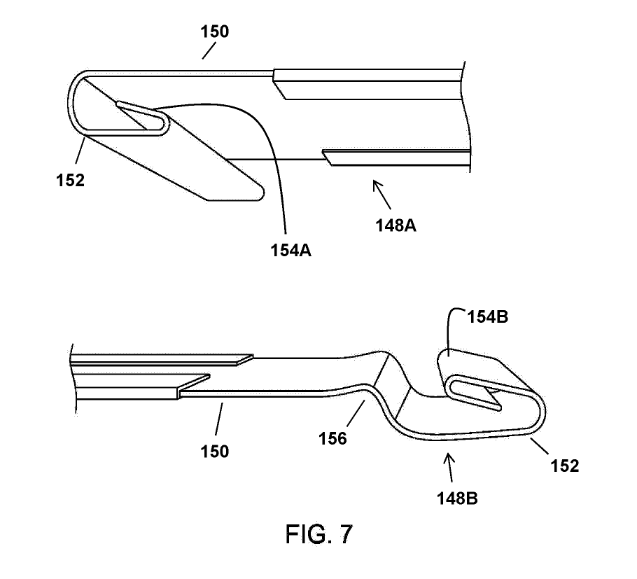

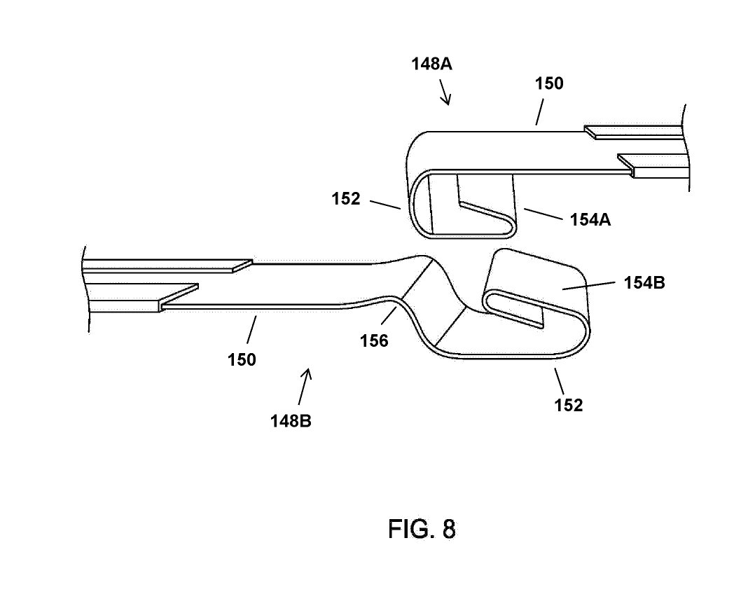

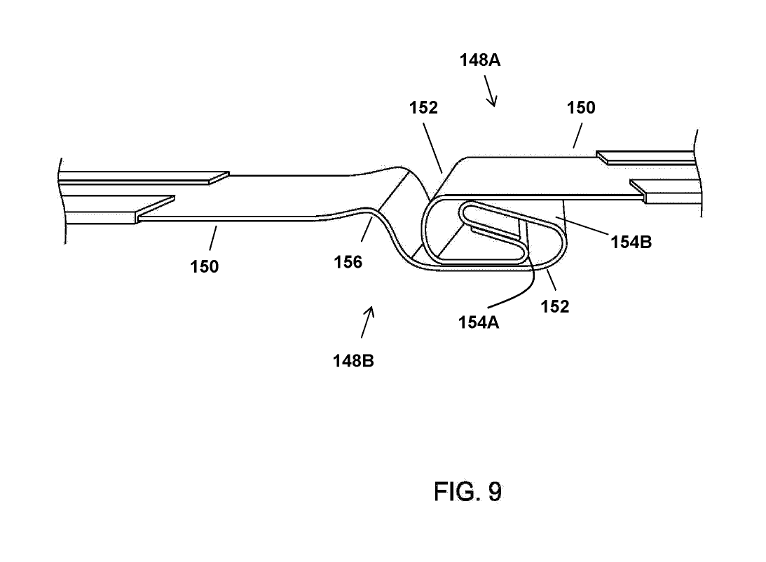

FIGS. 7-9 show a plurality of perspective views of an example embodiment of a first segment of a duct being interlocked with a second segment of a duct according to the present disclosure. Some elements of these figures are described above. Thus, same reference characters identify identical and/or like components described above and any repetitive detailed description thereof will hereinafter be omitted or simplified in order to avoid complication.

The duct 100 can comprise a first segment 148A and a second segment 148B, which can be at least one of a longitudinal portion, a lateral portion, or a diagonal portion of the duct 100. The first segment 148A and the second segment 148B are structured to interlock with each other at least one of detachably, removably, permanently, or selectively. For example, at least a portion of at least one of the portion 102, the portion 104, or at least one of the walls 106 can comprise or be defined via at least one of the first segment 148A or the second segment 1486. In some embodiments, the first segment 148A and the second segment 148B can further couple to each other via being at least one of fastened, magnetized, adhered, hook-and-looped, mated, bonded, buttoned, or any other type of coupling, whether mechanical, chemical, thermal, or electrical, whether selectively adjustable, such as incremental, or non-adjustable. For example, the first segment 148A and the second segment 148B can be interlocked with each other, while being magnetically coupled to each other, such as for an even tighter interlocking. Note that other coupling manners can also be used, whether additionally or alternatively, such as at least one of adhering or mating, such as via a depression and a projection, respectively.

In some embodiments, the first segment 148A and the second segment 148B can at least one of thermally or electrically couple to each other. Such coupling can be via flush contact, mating, or any other manner to allow for at least one of thermal or electrical conduction. For example, in electrical mating, the first segment 148A comprises a male connector and/or a female connector configured for electrically mating with a male connector and/or a female connector of the second segment 1486, respectively. Although a single male/female connector pair is described, in some embodiments, more than one male/female connector pair is used. The male/female connector of at least one of the first segment 148A or the second segment 1486 can be unitary to and/or assembled with at least one of the first segment 148A or the second segment 148B. For example, the male connector can be arcuate outward and the female connector can be arcuate inward for engagingly mating with each other. However, note that other shapes are possible, such as an I-shape, a T-shape, a V-shape, or others. The male connector or the female connector in the first segment 148A or the second segment 148B, respectively, can comprise at least one electrical interface connector in contact with at least one electrically conductive wire extending along the first segment or the second segment, respectively. When the first segment 148A and the second segment 148B are interlocking with each other such that the male connector and the female connector engagingly mate with each other, the male connector and the female connector electrically interface with each other to create a path, such as a circuit, for conduction of at least one of electricity or data. In some embodiments, at least one pair of the male connector and the female connector comprise a pair of corresponding electrical contacts, such as a pair of leads. For example, an electrical circuit can be created along any portion of the duct 100, such as at least one of the portion 102, the portion 104, at least one of the walls 106, or the insulation layer, such as via an electrically conductive wire, whether at least one of internal or external thereto, when electrical current can flow across the first segment 148A and the second segment 148B via such electrical contacts as the electrical contacts are in electrical contact with each other based on the first segment and the second segment being interlocking and electrically mating with each other.

The first segment 148A is J-shaped, as defined via a first planar portion 150 and a second planar portion 152. The first segment 148A comprises a tail 154A extending from the portion 152 inwardly. The first portion 150, the second portion 152, and the tail 154A are unitary, but can be assembled in any permutational or combinatory manner, as disclosed herein. The first segment 148A can comprise any properties, characteristics, or devices as disclosed herein.

The second segment 148B is offset J-shaped, as defined via the first planar portion 150, a bend 156 outward in the first portion 150, and the second planar portion 152. The second segment 148B comprises a tail 154B extending from the portion 152 inwardly. The second portion 150, the second portion 152, and the tail 154B are unitary, but can be assembled in any permutational or combinatory manner, as disclosed herein. The second segment 148B can comprise any properties, characteristics, or devices as disclosed herein, whether identical to or different from the first segment 148A.

Note that although FIGS. 7-9 show the first segment 148A being J-shaped with the inward tail 154A/being G-shaped, in some embodiments, the first segment 148A is shaped differently, such as S-shaped with the inward tail 154A, U-shaped with the inward tail 154A, or any other shape configured for interlocking. Likewise, note that although FIGS. 7-9 show the second segment 148B being offset and J-shaped with the inward tail 154B/being G-shaped, in some embodiments, the second segment 148B is shaped differently, such as S-shaped with the inward tail 154B, U-shaped with the inward tail 154B, or any other shape configured for interlocking. In some embodiments, the second segment 148B is not offset, such as without the bend 156. Note that at least one of the first segment 148A or the second segment 148B can be configured to be shaped in a pointed or a rounded manner in at least one corner.

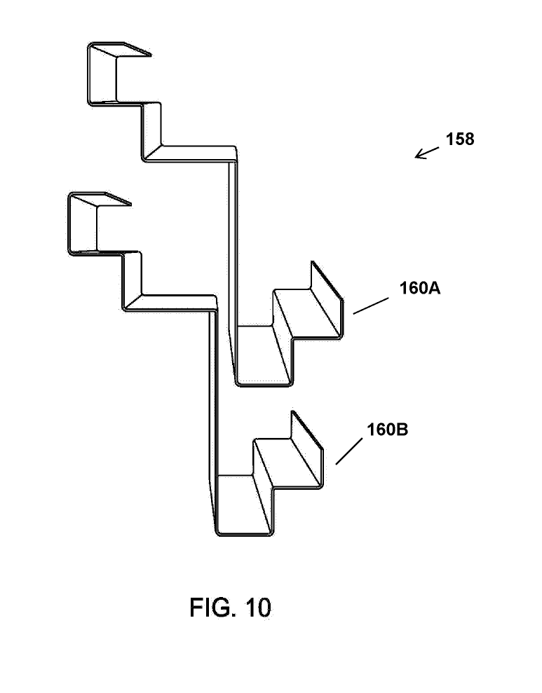

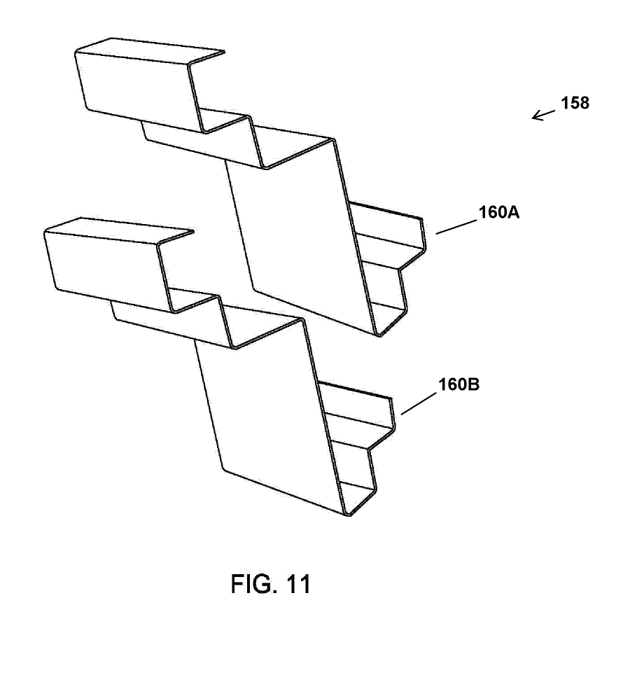

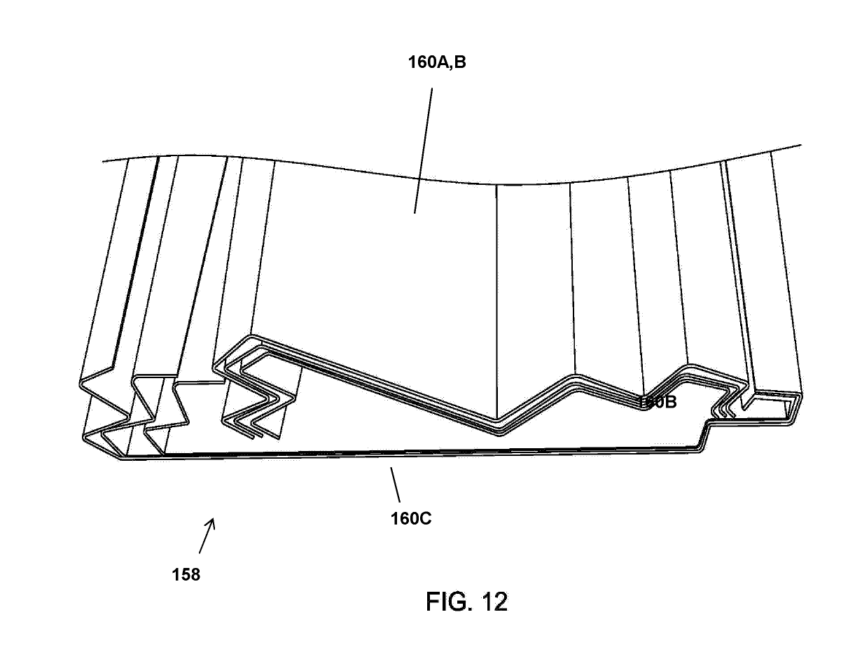

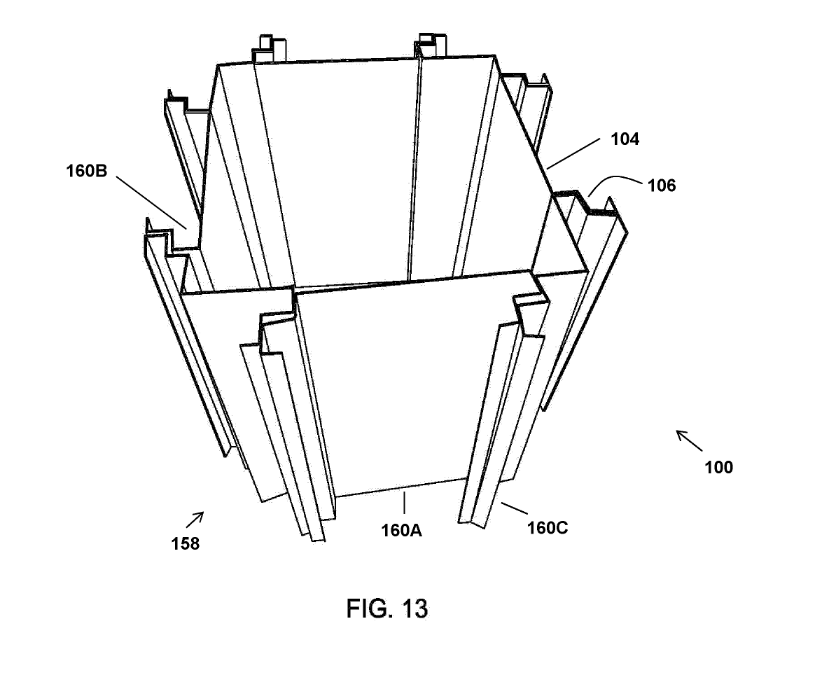

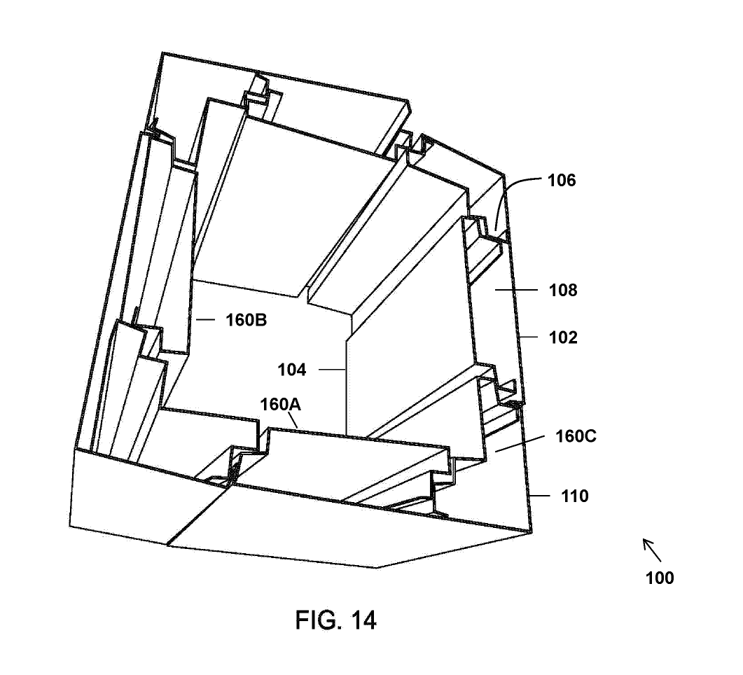

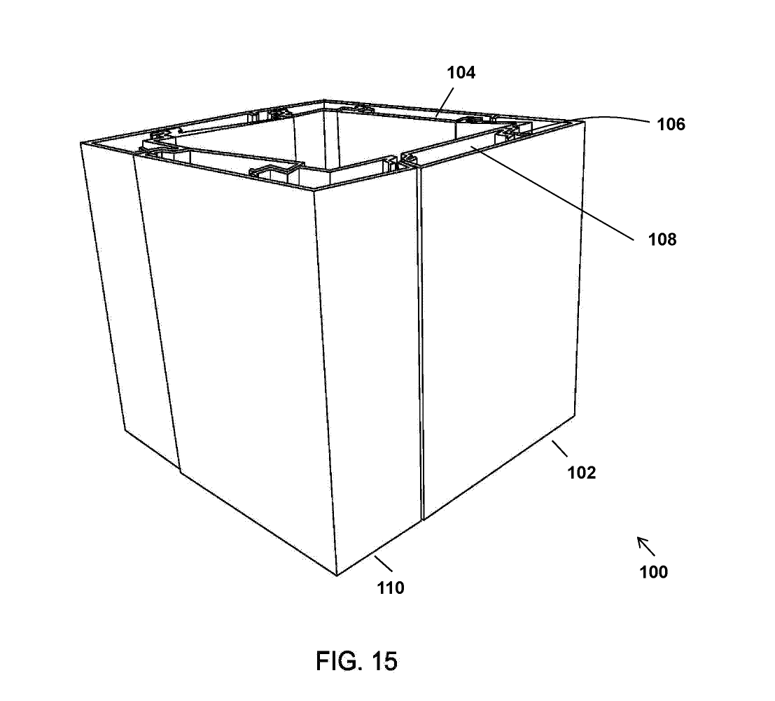

FIGS. 10-12 show a plurality of perspective views of an example embodiment of a plurality of duct segments according to the present disclosure. FIGS. 13-15 show a plurality of perspective views of an example embodiment of a duct assembled via a plurality of duct segments according to the present disclosure. Some elements of these figures are described above. Thus, same reference characters identify identical and/or like components described above and any repetitive detailed description thereof will hereinafter be omitted or simplified in order to avoid complication.

A plurality of duct segments 158 is structured and arranged to define the portion 102, the portion 104, or at least one of the sidewalls 106. For example, the duct 100 can be assembled via the duct segments 158, in whole or in part. At least one of the duct segments 158 can be configured to be shaped in a pointed or a rounded manner in at least one corner, whether oriented perpendicularly or non-perpendicularly, such as acute or obtuse. As shown, each of the duct segments 158 comprises a pair of N/Z/W/M-shaped sections joined via a bridge, which spans therebetween. Note that various measurements of the duct segments 158 are examples and other duct segment sizes, shapes, or orientations can be used, as understood to skilled artisans in light of this disclosure. The duct segments 158 comprise a segment 160A, a segment 160B, and a segment 160C, which can be identical to or different from each other in structure, such as shape, size, material, properties, or other characteristics. Although each of the segment 160A, the segment 1606, and the segment 160C is unitary, at least one of the segment 160A, the segment 160B, or the segment 160C can be assembled in any permutational or combinatory manner, as disclosed herein. Note that the segment 160A and the segment 160B can be stackable, such as snugly. Note that the segment 160C can contain or support a stack comprising the segment 160 and the segment 160B. For example, the segments 158 can be shipped in a stacked manner, such as in a cargo container, and then assembled into the duct 100, as disclosed herein.

The segments 110 are arranged to define the portion 102 and at least one channel 108. Therefore, the duct 100 may be assembled, in whole or in part. Although some of the segments 158 are right-angled, in other embodiments, at least some of the segments 158 can be non-right-angled, such as obtuse or acute. Note that at least some of the segments 158 are stackable. Note that at least some of the segments 158 can include circuitry, computers, sensors, or any other devices or characteristics or properties are disclosed herein.

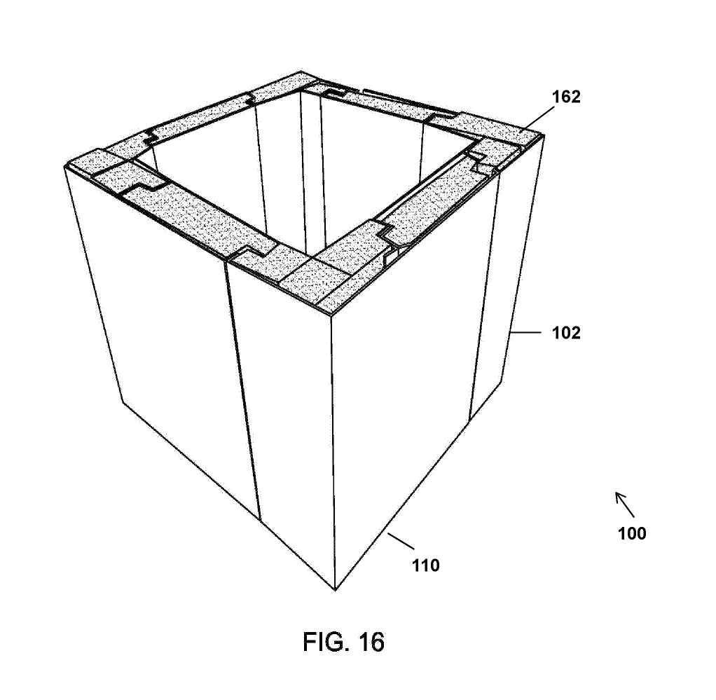

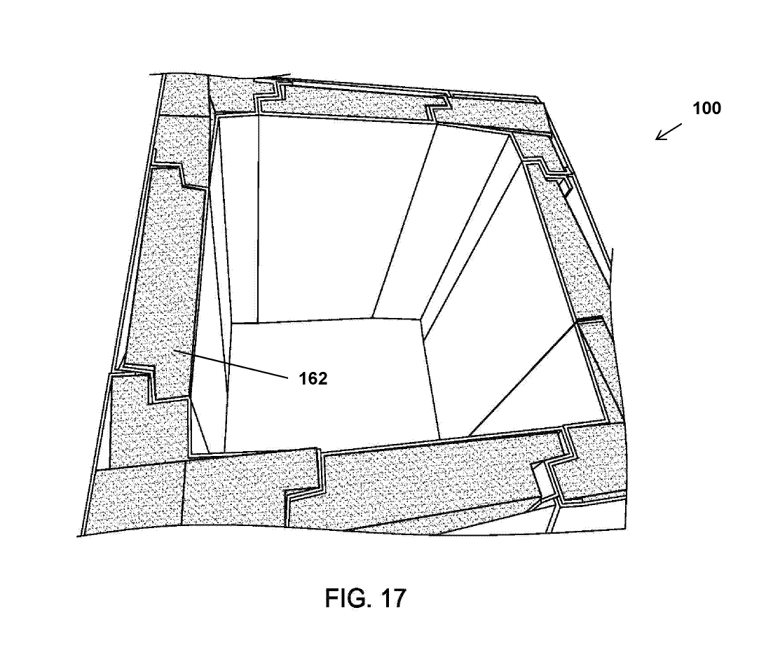

FIGS. 16-17 show a plurality of perspective views of an example embodiment of a duct assembled via a plurality of duct segments and containing a plurality of insulating segments according to the present disclosure. Some elements of these figures are described above. Thus, same reference characters identify identical and/or like components described above and any repetitive detailed description thereof will hereinafter be omitted or simplified in order to avoid complication.

The channels 108 are filled with a plurality of insulating segments 162 in any correspondence, such as one-to-one, one-to-many, many-to-one, or many-to-many. In some embodiments, at least one of the channels 108 comprises a single insulating segment 162. In some embodiments, at least one of the channels 108 comprises at least two of the insulating segments 162. In some embodiments, at least two of the channels 108 comprise a single insulating segment 162, such as via being accessible to each other through an aperture in at least one of the walls 106. In some embodiments, at least two of the channels 108 comprise at least two of the insulating segments 162. At least one of the insulating segments 162 can be the insulating layer, as disclosed herein. In some embodiments, at least one of the insulating segments 162 can be formed before insertion into at least one of the channels 108 and then inserted into at least one of the channels 108. In some embodiments, at least one of the insulating segments 162 can be formed via blowing, pouring, or otherwise inserting or placing an insulating material into the channels 108 and then letting the material dry, cure, or harden to form at least one of the segments 162. Note that the portion 102, the portion 104, and the walls 106 may be held in place via the insulating segments 162 outwardly expanding and applying outward pressure onto the portion 102, the portion 104, and the walls 106. Therefore, the duct 100 remains erect or functionally sound.

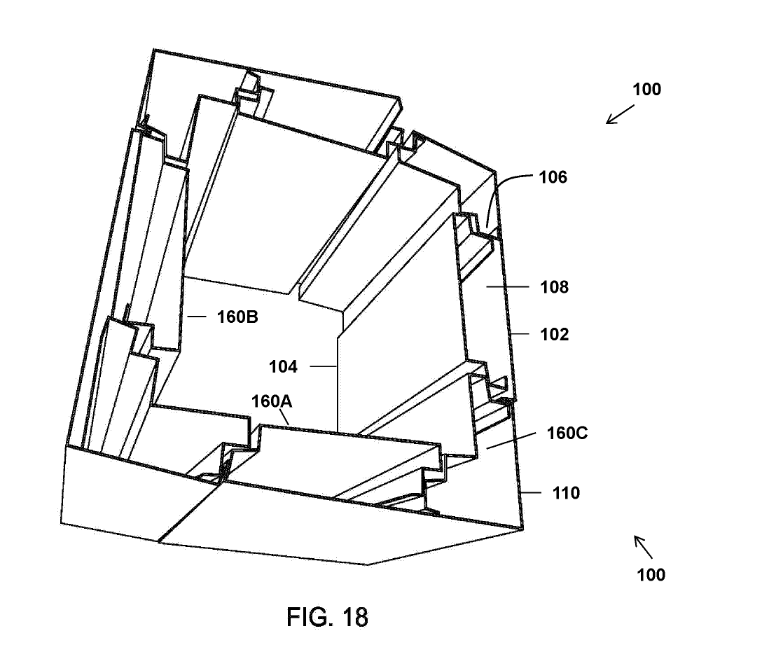

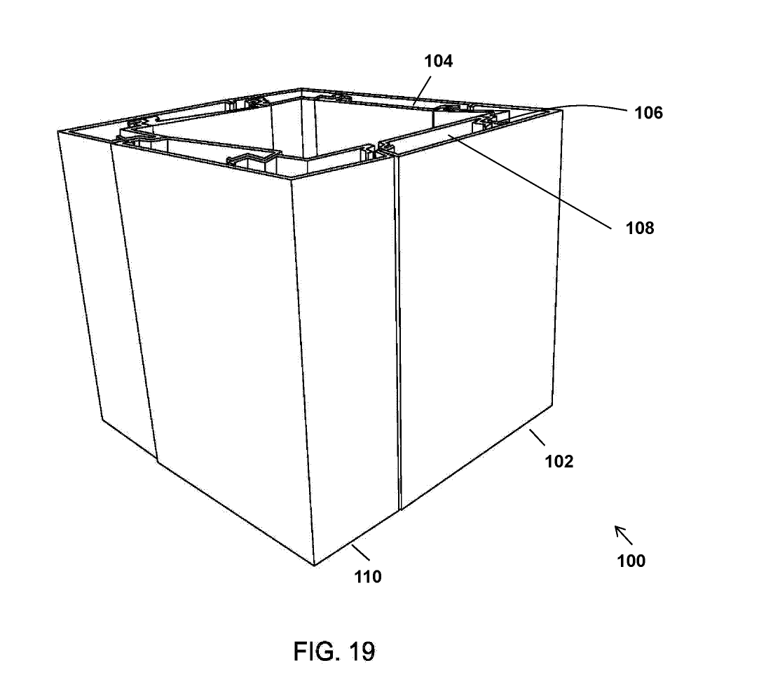

FIGS. 18-19 show a plurality of perspective views of an example embodiment of a duct assembled via a plurality of duct segments and lacking a plurality of insulating segments according to the present disclosure. Some elements of these figures are described above. Thus, same reference characters identify identical and/or like components described above and any repetitive detailed description thereof will hereinafter be omitted or simplified in order to avoid complication.

The insulating segments 162 can be selectively removed from the duct 100, such as for construction, maintenance, upgrade, or moving. In some embodiments, the duct 100 is operated without the segments 162 and the channels 108 are used to store or contain other materials, such as a fluid, such as a liquid or a gas, a wire or a cable, a vacuum, a volume of sand, a solid, or others.

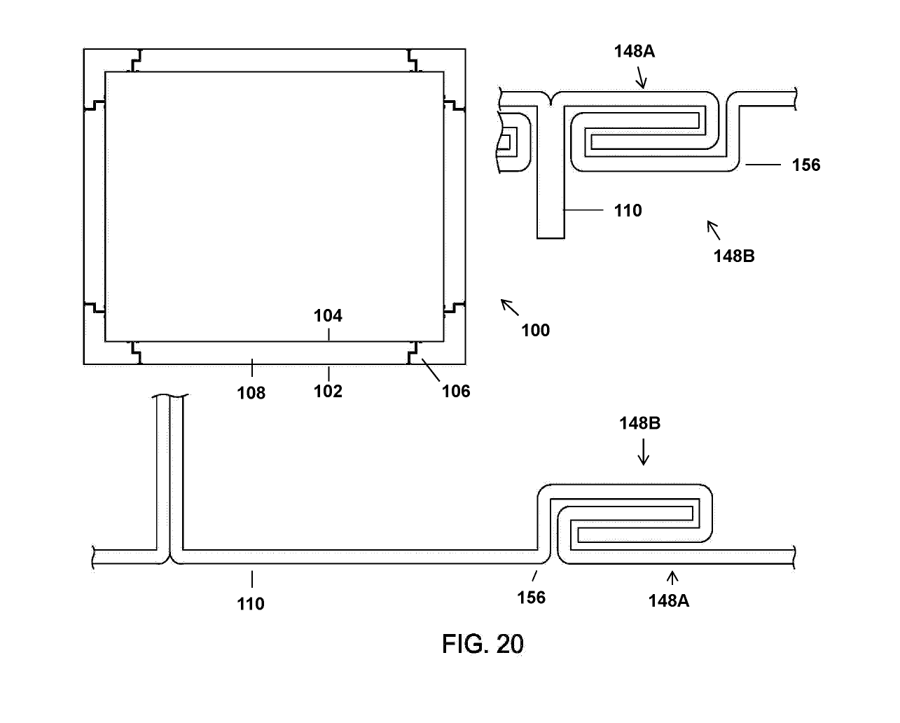

FIGS. 20-22 show a plurality of schematic diagrams depicting a plurality of example embodiments of duct technologies according to the present disclosure. Some elements of these figures are described above. Thus, same reference characters identify identical and/or like components described above and any repetitive detailed description thereof will hereinafter be omitted or simplified in order to avoid complication. Note that such schematic diagrams are examples and other structures, sizes, or properties can be used, as understood to skilled artisans in light of this disclosure.

As shown in FIG. 20, at least one of the segments 110 comprises at least one of the first segment 148A or the second segment 148B for interlocking or secure engagement, as disclosed herein.

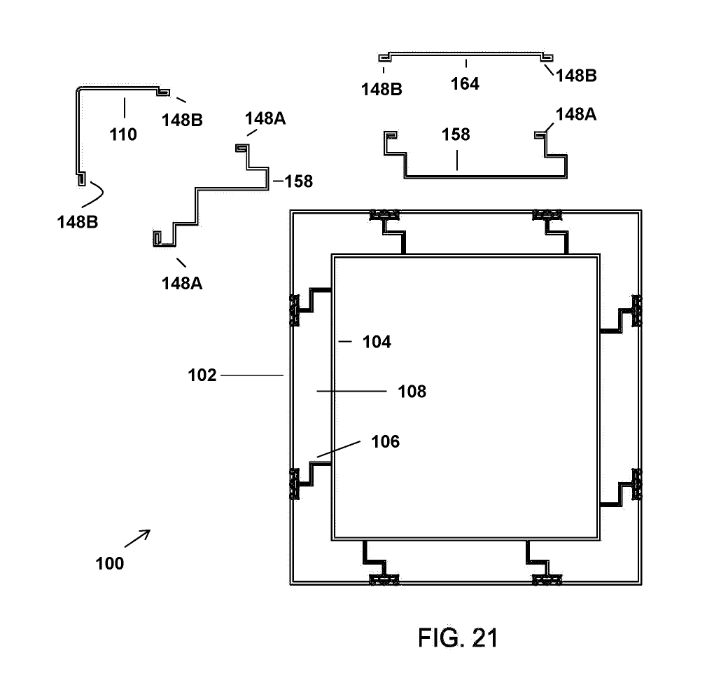

As shown in FIG. 21, the segments 158 comprise a segment 164, which can comprise at least one of the first segment 148A or the second segment 148B. Note that the segment 164 includes a rectilinear bridge between the segments 148B of the segment 164. The segment 164 can interlock or securely engage with a corresponding segment 158 comprising the segments 148A, as disclosed herein. Note that the segment 110 comprises the segments 148B to engage with the segments 158 comprising the segments 148A, as disclosed herein.

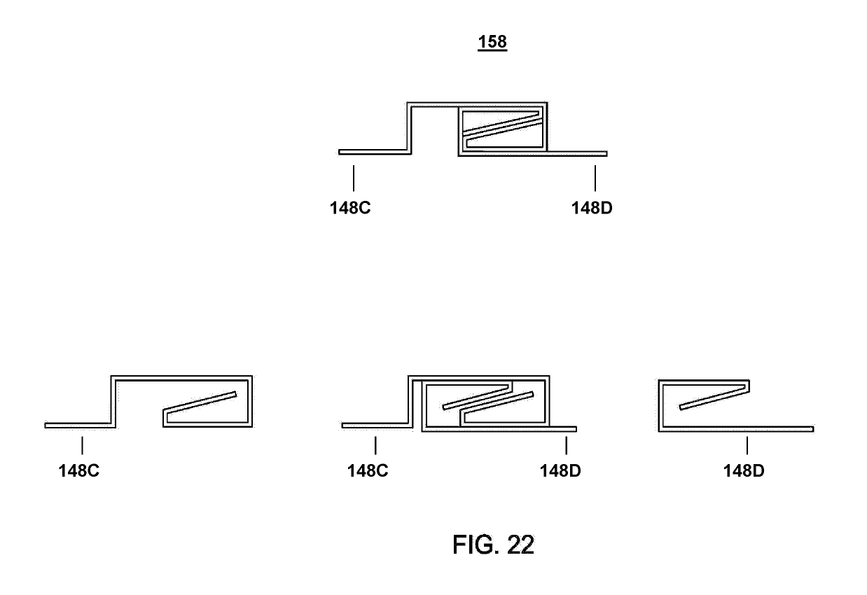

As shown in FIG. 22, the segments 158 include a plurality of segments 148C, 148D, which are structured similar to the segments 148A, 148B. The segments 148C, 148D can interlock or securely engage with each other, as disclosed herein.

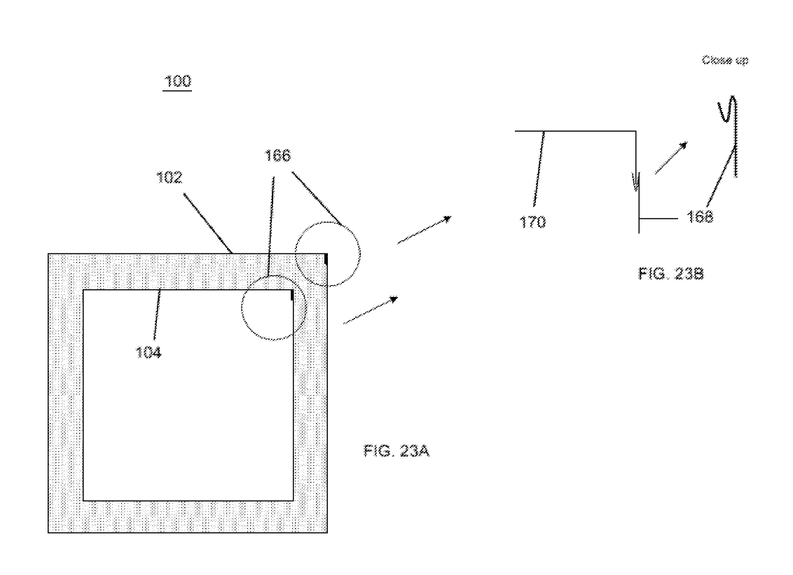

FIGS. 23A-B show an embodiment of a duct interlocking at a corner according to the present disclosure. Some elements of these figures are described above. Thus, same reference characters identify identical and/or like components described above and any repetitive detailed description thereof will hereinafter be omitted or simplified in order to avoid complication. Note that such schematic diagrams are examples and other structures, sizes, or properties can be used, as understood to skilled artisans in light of this disclosure.

At least one of the outer portion 102 or the inner portion 104 comprises at least one of an outer corner 166 or an inner corner 166, respectively. At a respective corner 166, two immediately adjacent sections of the duct 100 interlock or securely engage. Such two sections include a first portion 170, which functions as a male portion, and a second portion 168, which functions as a female portion. Such interlocking, such as via mating, keeps the portion 170 and the portion 168 continuous, yet with a seam or being non-flush from the portion 168. Note that such interlocking can be enhanced via a complementary method of coupling, such as via adhesives, magnets, hook-and-loops, fasteners/nuts/bolts/screws, bonding, melting, or others. Note that the inner corner 166, the outer corner 166, neither, or both can be secured in any of such manners, whether via interlocking or complementary methods or other methods as disclosed herein. Note that any structural integrity monitoring of the duct 100 via a sensor, as disclosed herein, can include monitoring a status of such engagement or complementary methods.

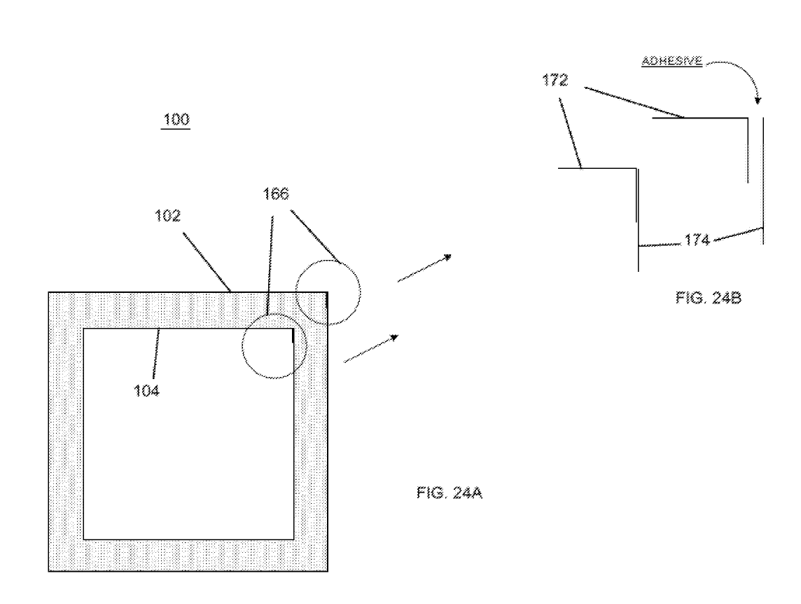

FIGS. 24A-B show an embodiment of a duct engagement at a corner according to the present disclosure. Some elements of these figures are described above. Thus, same reference characters identify identical and/or like components described above and any repetitive detailed description thereof will hereinafter be omitted or simplified in order to avoid complication. Note that such schematic diagrams are examples and other structures, sizes, or properties can be used, as understood to skilled artisans in light of this disclosure.

At least one of the outer portion 102 or the inner portion 104 comprises at least one of the outer corner 166 or the inner corner 166, respectively. At a respective corner 166, two immediately adjacent sections of the duct 100 securely engage. Such two sections include a first portion 172 and a second portion 174. Such engagement, such as via an adhesive, keeps the portion 172 and the portion 174 continuous, yet with a seam or being non-flush from the portion 174. Note that such engagement can be enhanced via a complementary method of coupling, such as via maters, magnets, hook-and-loops, fasteners/nuts/bolts/screws, bonding, melting, or others. Note that the inner corner 166, the outer corner 166, neither, or both can be secured in any of such manners, whether via engagement or complementary methods or other methods as disclosed herein. Note that any structural integrity monitoring of the duct 100 via a sensor, as disclosed herein, can include monitoring a status of such engagement or complementary methods.

In some embodiments, the duct 100 can be operated with or in intelligent circulation control systems, as disclosed in U.S. Pat. No. 8,555,662, which is herein fully incorporated by reference for all purposes. For example, when the duct 100 comprises a sensor, then such sensor can provide output or otherwise aid in intelligent circulation control.

In some embodiments, the duct 100 can be operated with or in HVAC systems, as disclosed in U.S. Pat. No. 5,544,809, which is herein fully incorporated by reference for all purposes. For example, when the duct 100 comprises a sensor, then such sensor can provide output or otherwise aid in HVAC system control.

In some embodiments, the duct 100 can contain a filter to filter a fluid conducted therein, as disclosed in U.S. Pat. No. 6,814,660 or United States Patent Application Publication 2006/0102006, which are herein fully incorporated by reference for all purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be fully exhaustive and/or limited to the disclosure in the form disclosed. Many modifications and variations in techniques and structures will be apparent to those of ordinary skill in the art without departing from the scope and spirit of the disclosure as set forth in the claims that follow. Accordingly, such modifications and variations are contemplated as being a part of the present disclosure. The scope of the present disclosure is defined by the claims, which includes known equivalents and unforeseeable equivalents at the time of filing of the present disclosure.

1. A method comprising:
accessing a duct comprising an outer portion and an inner portion, wherein the outer portion comprises an L-shaped segment comprising a first end portion and a second end portion, wherein the first end portion comprises a first winglet extending therefrom, wherein the second end portion comprises a second winglet extending therefrom, wherein the first winglet and the second winglet contact the inner portion such that a channel is defined between the L-shaped segment and the inner portion;
conducting a fluid through the inner portion.

2. The method of claim 1, wherein the inner portion comprises a plate comprising a first end section and a second end section, wherein the first end section comprises a first wing extending therefrom, wherein the second end section comprises a second wing extending therefrom, wherein the L-shaped segment comprises an inner corner between the first end portion and the second end portion, wherein at least one of the first wing or the second wing extends towards the inner corner.

3. The method of claim 2, wherein the channel contains an insulation therein such that the insulation is interposed between the outer portion and the inner portion.

4. The method of claim 1, wherein the fluid is sourced from a HVAC device.

5. The method of claim 4, wherein the inner portion comprises a sensor sensing for a substance harmful for humans to inhale, wherein the sensor senses during the conducting.

6. The method of claim 1, wherein the outer portion comprises a photovoltaic cell.

7. A method comprising:
accessing a duct comprising an outer portion and an inner portion, wherein the outer portion and the inner portion is defined via a segment comprising an L-shaped portion and a plate portion, wherein the L-shaped portion comprises a first end portion and a second end portion, wherein the L-shaped segment comprises an inner corner between the first end portion and the second end portion, wherein the first end portion comprises a first winglet extending therefrom, wherein the second end portion comprises a second winglet extending therefrom, wherein the plate portion comprises a plate comprising a first end section and a second end section, wherein the first end section comprises a first wing extending therefrom, wherein the second end section comprises a second wing extending therefrom, wherein at least one of the first winglet or the second winglet contacts the plate between the first wing and the second wing, wherein at least one of the first wing or the second wing extends towards the inner corner;
conducting a fluid through the inner portion along the plate.

8. The method of claim 7, wherein the outer portion and the inner portion define a channel between the L-shaped portion and the plate portion.

9. The method of claim 8, wherein the channel contains an insulation therein such that the insulation is interposed between the outer portion and the inner portion.

10. The method of claim 7, wherein the fluid is sourced from a HVAC device.

11. The method of claim 10, wherein the inner portion comprises a sensor sensing for a substance harmful for humans to inhale, wherein the sensor senses during the conducting.

12. The method of claim 7, wherein the outer portion comprises a photovoltaic cell.

13. A method comprising:
accessing a duct comprising an outer portion and an inner portion, wherein the inner portion comprises a segment comprising a plurality of W-shaped portions and a bridge portion, wherein the bridge portion spans between the W-shaped portions;
conducting a fluid through the inner portion along the bridge portion.

14. The method of claim 13, wherein the outer portion and the inner portion define a channel therebetween.

15. The method of claim 14, wherein the channel contains an insulation therein such that the insulation is interposed between the outer portion and the inner portion.

16. The method of claim 13, wherein the fluid is sourced from a HVAC device.

17. The method of claim 16, wherein the inner portion comprises a sensor sensing for a substance harmful for humans to inhale, wherein the sensor senses during the conducting.

18. The method of claim 13, wherein the outer portion comprises a photovoltaic cell.
